(19) United States
(12) Patent Application Publication
(10) Pub. No.: US 2002/0088851 A1
(43) Pub. Date: Jul. 11, 2002

(54) Method and apparatus for point of sale activated delivery of products or services

(76) Inventor: Mark B. Hodes, Memphis, TN (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 10/008,306

(22) Filed: Dec. 7, 2001

Related U.S. Application Data
(60) Provisional application No. 60/260,058, filed on Jan. 5, 2001.

(51) Int. Cl. G06K 5/00

(52) U.S. Cl. 235/380

(57) ABSTRACT

This invention provides method and apparatus for the point of sale activated delivery of various products and services. The serial number of a product or service is associated with an identification number. The identification number is recorded on a card. The identification number is activated at the point of sale. This active identification number can be used to facilitate the delivery of various products and services. Various devices comprising a card and package combination are provided.

### RELATED APPLICATIONS

This application claims priority under 35 USC Sec. 119(e), based on U.S. Provisional Application, Serial No. 60/260,058, filed Thursday Jan. 5, 2001. This application also claims priority under 35 USC Sec. 120, based on U.S. Patent Application assigned Provisional Serial No. P-105,049, filed Oct. 26, 2001; and this application is a continuation-in-part of U.S. patent application Ser. No. P-105,049.

### STATEMENT REGARDING FEDERALLY SPONSORED RESEARCH OR DEVELOPMENT

NOT APPLICABLE

### FIELD OF THE INVENTION

The present invention relates to a method for point of sale activated delivery of products and services and the related apparatus.

### BACKGROUND OF THE INVENTION

Banks have issued debit and credit cards to consumers to give consumers access to their savings and checking accounts. These transactions are conducted on VISA®/MasterCard® banking network. In addition to debit and credit transactions using swipe activated cards, other services have been added to cards capable of being processed in standard banking routes. For example, Dorf in U.S. Pat. No. 6,000,608 discloses a multi functional card capable of serving as a prepaid phone card, a debit card, a loyalty card and a medical information card. A standard point of sale terminal device reads the multi functional Dorf card, in the same manner as a credit or debit card, and routes the transaction via VISA®/MasterCard® network to a processing hub. The processing hub in the case of the prepaid phone card routes the transaction to a prepaid phone hub.

A segment of the population, however, does not have debit or credit cards. This segment of the population may comprise 30 percent of the population. Prepaid stored value cards and phone cards are used by this segment of the population. These cards are associated with metered accounts. The account is debited when the consumer makes a purchase or uses the phone card. One such package/card combination is disclosed by Fiala et al. U.S. Pat. No. 5,918,909 (hereby incorporated by reference). The Fiala card includes a data encoded stripe. When the card is purchased a control number is read from the data encoded stripe and the metered account is activated.

It has been heretofore unrecognized that point of sale activated cards can be used to provide a variety of products and services that cannot be delivered with simple metered accounts.

### SUMMARY OF THE INVENTION

This invention provides activated delivery of products such as software, music and entertainment content, and services such as satellite broadcasting, ISP, DSL, warranty contracts, and insurance contracts (service contracts) and utilities. More specifically, a card and package combination provides a system that allows inactive product sales, to be activated using all forms of electronic communication. With this package delivery system, prior to swipe activation of the delivery means the packaged goods are inactive or even not present, eliminating product pilferage. Additionally, this invention provides a method to prepay for services and for providers of services or goods to validate a sale by associating a PIN or PAN number with a unique number of a product. Additionally, this invention provides a method to prevent consumer sharing of software by creating an association between an activated identification number and the computer and/or modem used in the registration process.

According to a first aspect of the present invention, a delivery device is provided for use in a system for point of sale activated delivery of products or services. In one preferred embodiment, the delivery device comprises a package, a content storage device retained by the package and a data-encoded card secured to the package. The data-encoded card includes a data-containing portion which is readable by a point of sale terminal device, with the data-containing portion including at least one unique identification number thus creating an association file for managing product activation. The package may assume various configurations, as subsequently discussed in greater detail, a wide variety of content storage devices may be retained by the package, and a variety of data-encoded cards may be used.

For instance, in one embodiment, the package includes first and second panels attached to one another and further includes a scored interface between the first and second panels which facilitates folding one of the panels on top of the other panel. Each of the panels may optionally include an aperture formed in an upper portion thereof, with the apertures being aligned when the package is in a closed position such that the apertures are suitable for receiving a display rack rod or the like used to support and display the delivery device, for instance in a retail store. The package further includes an insert made of a light-emitting material, with the insert including a container portion protruding through an aperture formed in one of the panels and protruding beyond an outer surface of the panel. The insert further includes a peripheral flange integral with the container portion adjacent an open top of the container portion, with the flange being secured to an inside surface of the panel.

The package may optionally include a notch formed in a lower portion of one of the panels and a window made of a light-emitting material such as Mylar®, secured to the panel and including a pane extending across the notch so that at least a portion of one surface, typically the front surface, of the data-encoded card is viewable from a position exterior of the delivery device. The aperture for receiving the previously discussed insert, and the notch may either be formed in the same or different ones of the panels of the package.

In another embodiment, the package comprises a box having a flap, with the content storage device being disposed within the box and the data-encoded card being secured to the flap such that the card is obscured from view in a normal display position.

In yet another embodiment, the package comprises a single panel with an aperture formed in the panel to receive a light-emitting insert as discussed previously. The panel may further include another aperture formed in an upper portion thereof to receive a display rack rod or the like. In this embodiment, the single panel includes a laterally extending score forming an interface between a lower portion of the panel and a remaining portion of the panel such that the lower portion panel is bendable away from the data-encoded card to reveal a lower portion of the card for swipe activation. An upper portion of the card is secured to the panel at a position above the laterally extending score.

The content storage device, which is retained by the package of the delivery device, may comprise a wide variety of devices. For instance, the content storage device may be an optical disk, a magnetic disk, a compact disk containing music thereon, a game cartridge and a book. Furthermore, the content storage device may include a box and a device disclosed within the box, with the device comprising at least one of an optical disk, a magnetic disk, a compact disk containing music thereon, a game cartridge and a book.

The data-encoded card includes front and rear surfaces and, in one embodiment, the data-containing portion comprises a magnetic stripe disposed on one of the front and rear surfaces. The magnetic stripe may be laminated or rolled onto this surface. The magnetic stripe is encoded with a unique identification number that is correlated with a product or service to be delivered.

The data-encoded card may further include a smart chip secured to the same surface of the card that includes the magnetic stripe. The smart chip's memory provides and saves information unique to the card's activity.

In other embodiments, the card may further include either a bar code or a hard drive ridge disposed on the same surface of the card as the magnetic stripe.

In another embodiment, the data-containing portion of the data-encoded card may comprise a hard drive ridge with no magnetic stripe being used.

According to another aspect of this invention, a method to provide point of sale activated delivery of a product or a service is provided. This method involves providing a data encoded card, the data including an identification number facilitating the delivery of said product or said service; facilitating activation of the identification number at a point of sale; and facilitating delivery of the product or the service associated with the identification number.

According to another aspect of this invention, a method to facilitate delivery of a product from a provider to a consumer is provided. This method involves associating a serial number of the product with an identification number; recording the identification number on a card; activating the identification number on the card at a point of sale; and facilitating a delivery of the product from the provider to the consumer.

According to another aspect of this invention, a method to facilitate delivery of a service from a provider to a consumer is provided. This method involves providing an identification number associated with the service; recording the identification number on a card, activating the identification number on the card at a point of sale; and facilitating delivery of the service from the provider to the consumer.

According to another aspect of this invention, a method of using a card and package combination to activate delivery of a product or a service from a provider, the card including a data encoded portion, the card being secured to a package is provided. This method involves encoding an identification number on to the data encoded portion of the card; using a POS terminal device to read the encoded identification number while the card is secured to a package; then transmitting the identification number from a POS terminal device to a transaction manager; activating the identification number by the transaction manager; then providing the active identification number to the provider by the transaction manager; requesting delivery of a product or a service by a consumer from the provider by providing the active identification number to the provider; and delivering the product or the service to a consumer from the provider in response to the provider receiving the active identification number.

According to another aspect of this invention, a method of using a card and package combination to activate delivery of a product or a service by a provider, the card and package combination comprising a package and the card including a data encoded portion, the card being secured to a package is provided. This method involves encoding an identification number on to the data encoded portion of the card; using a POS terminal device to read the encoded identification number, while the card is secured to a package; then transmitting the identification number from the POS terminal device to a provider; activating the identification number by the provider; then requesting delivery of a product or a service by a consumer from the provider, by providing the active identification number to the provider; and delivering the product or the service to the consumer from the provider in response to provider receiving the active identification number.

According to another aspect of this invention, a method of using a card to facilitate delivery of aproduct to a consumer, the card including at least one data encoded portion is provided. This method involves encoding an identification number on to at least one data encoded portion of the card; using a POS terminal device to read an encoded identification number on the card; then transmitting the identification number from the POS terminal device to a transaction manager or a provider; activating the identification number by the transaction manager or the provider; transmitting the active identification number to a POS terminal device, providing the active identification number from the POS terminal device to a consumer; and facilitating the delivery of the product, by the consumer providing the provider with the active identification number.

According to another aspect of this invention, a method to administer contracted services is provided. This method involves providing a data encoded card having a pre-determined contract value and an identification number associated with the pre-determined contract value; facilitating activation of the identification number at a point of sale; and facilitating delivery of the contracted services.

According to another aspect of this invention, a method of using a card having a data encoded portion to administer contracted services is provided. This method involves associating a pre-determined contract value and an identification number; encoding the identification number on to the data encoded portion of the card to provide an administration of contract card; issuing the administration of contract card at a point of sale to a consumer; transmitting the identification number from a POS terminal device to a transaction manager; activating the identification number by the transaction manager to provide an activated administration of contract card; opening a file associated with the identification number by the transaction manager; redeeming the activated administration card by transmitting the identification number from the POS terminal device to a transaction manager; and authorizing the contracted services.

According to another aspect of this invention, a method to provide point of sale generated access to a remote file in a transaction between a merchant, provider, transaction manager and a consumer is provided. This method involves providing a card having a data encoded portion, the encoded data including an identification number; reading the data encoded portion with a point of sale terminal device; transmitting the data from the point of sale terminal device to the transaction manager; activating the identification number by the transaction manager; transmitting the activated identification number to a provider from the transaction manager; accessing a provider's web site by the consumer; providing the identification number to the provider to obtain authorization for the consumer to access the remote file; and downloading the remote file to a content storage device.

According to another aspect of this invention, a method to provide point of sale generated access to a remote file in a transaction between a merchant, provider, and a consumer is provided. This method involves providing a card having a data encoded portion, the encoded data including an identification number; reading the data encoded portion with a point of sale terminal device; transmitting the data from the point of sale terminal device to provider; activating the identification number by the provider; accessing a provider's web site by the consumer; providing the identification number to the provider to obtain authorization for the consumer to access the remote file; and downloading the remote file to a content storage device.

According to another aspect of this invention, a method of providing a consumer with a data encoded card including an active identification number for providing activated delivery of products or services is provided. This method involves providing a card with a data writable portion capable of receiving an identification number; using a point of sale terminal device to contact a transaction manager; requesting an active identification number from the transaction manager; transmitting the active identification number from the transaction manager to the point of sale terminal wherein the point of sale terminal device encodes the active identification number on to the data writable portion of the card; and providing a consumer with the data encoded card including the active identification number.

According to another aspect of this invention, a method to prevent a consumer sharing of a software program owned by a software provider is provided. This method involves associating a serial number of a software program with an identification number; recording an identification number on a data encoded portion of a card; activating the identification number at a point of sale; providing the active identification number to the software provider by a consumer; transmitting a registration requirement to the consumer from the software provider, wherein the registration requirement associate a consumer's computer equipment with the identification number; and preventing consumer sharing of the software program by downloading the software program to the consumer's computer equipment associated with the active identification number.

According to another aspect of this invention, a method of using a card and package combination to activate delivery of software program or portion thereof from a provider to a consumer, the card including a data encoded portion and the card being secured to the package is provided. This method involves encoding an identification number on to the data encoded portion of the card; using a POS terminal device to read the encoded identification number from the data encoded portion of the card, while the card is secured to the package; then transmitting the identification number from the POS terminal device to the provider; then activating the identification number by the provider; providing the identification number to the provider by a consumer; transmitting a registration contract by the provider to the consumer in response to the identification number; transmitting a completed registration contract including consumer's computer serial number or modem serial number to the provider; and then delivering the software program or portion thereof to the consumer from the provider.

According to another aspect of this invention, a system for point of sale activated delivery of a product or a service is provided. This method involves a data encoded card, the data including a unique identification number facilitating the delivery of said product or said service; and transaction manager in electronic communication with a point of sale terminal.

According to another aspect of this invention, a system for point of sale activated delivery of a product or a service is provided. This system involves a data encoded card having a unique identification number facilitating the delivery of the product or service; and a provider in electronic communication with a point of sale terminal.

According to another aspect of this invention, a delivery device for use in a system for point of sale activated delivery of products or services is provided. This service involves a package; a content storage device retained by the package; and a data encoded card secured to the package, the data-encoded card including a data-containing portion which is readable by a point of sale terminal device, the data-containing portion including at least one unique identification number.

### BRIEF DESCRIPTION OF THE DRAWINGS

These and other features, aspects and advantages of the present invention will become better understood with regard to the following description, appended claims and accompanying drawings, wherein:

FIG. 1 is a front elevation view of a delivery device according to a first embodiment of the present invention, for use in a system for point of sale activated delivery of products or services;

FIG. 2 is a rear elevation view of the delivery device shown in FIG. 1;

FIG. 3 is a plan view of the package included in the delivery device shown in FIGS. 1 and 2, illustrating the inside surfaces of the included panels of the package;

FIG. 4 is a plan view of an insert included in the package shown in FIGS. 1-3;

FIG. 5 is a cross-sectional view taken along line 5-5 in FIG. 4;

FIG. 6 is a cross-sectional view taken along line 6-6 in FIG. 4;

FIG. 7 is a plan view of a window which is secured to one of the package panels illustrated in FIGS. 1-3;

FIG. 8 is a cross-sectional view taken along line 8-8 in FIG. 7;

FIG. 9 is a cross-sectional view taken along line 9-9 in FIG. 7;

FIG. 10 is a plan view similar to FIG. 3 except with the package window assembled to the left hand panel and the package insert assembled to the right hand panel;

FIG. 11 is a plan view of a front side of the data-encoded card included in the delivery device shown in FIGS. 1 and 2;

FIG. 12 is a plan view of the rear side of the data-encoded card shown in FIGS. 1, 2 and 11;

FIG. 13 is a plan view of the optical disk included in the delivery device shown in FIGS. 1 and 2;

FIG. 14 is a plan view similar to FIG. 10, but with the data-encoded card illustrated in FIGS. 1, 2, 11 and 12 secured to the right hand package panel and the optical disk shown in FIGS. 2 and 13 disposed within the package insert;

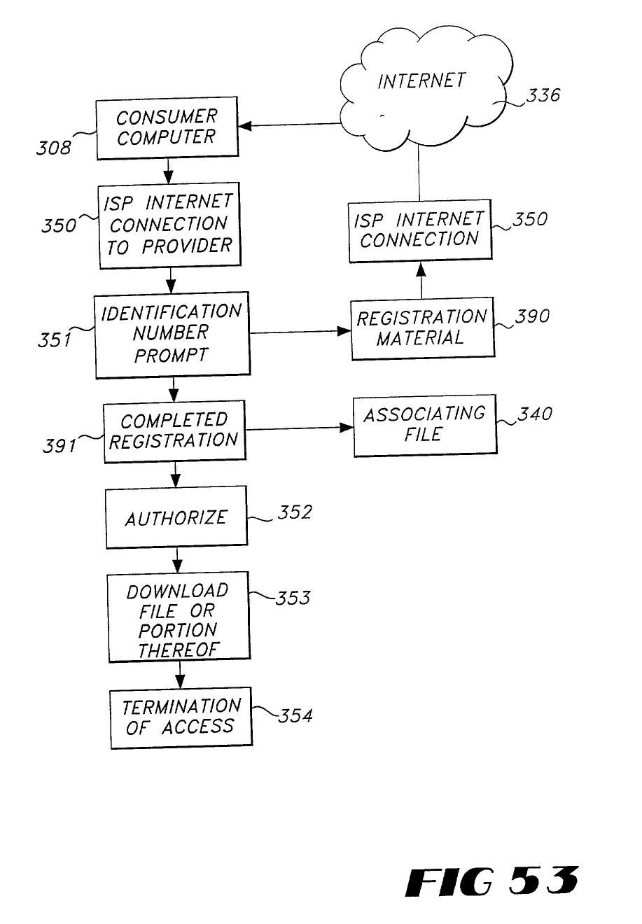

FIG. 1 is an isometric view further illustrating the delivery device shown in FIG. 14, but with the left hand package panel being rotated partially closed;

FIG. 16 is a plan view illustrating a rear surface of an alternative data-encoded card according to the present invention;

FIG. 17 is a plan view illustrating a rear surface of another alternative data-encoded card according to the present invention;

FIG. 18 is a cross-sectional view taken along line 18-18 in FIG. 17;

FIG. 19 is a plan view illustrating a rear surface of another alternative data-encoded card according to the present invention;

FIG. 20 is a plan view illustrating a rear surface of another data-encoded card according to the present invention;

FIG. 21 is a plan view of a computer diskette;

FIG. 22 is a plan view of a circular music CD;

FIG. 23 is a plan view of a game cartridge;

FIG. 24 is a perspective view of a book;

FIG. 25 is a perspective view of a box with a book being installed in the box;

FIG. 26 is a front elevation view illustrating a delivery device according to a second embodiment of the present invention, which includes the package illustrated in FIG. 27 and a data-encoded card secured to the package;

FIG. 27 is an elevation view of an alternative delivery device package illustrating the inside surfaces of the included panels;

FIG. 28 is a front elevation view of a delivery device according to an alternative embodiment of the present invention;

FIG. 29 is a rear elevation view of the delivery device illustrated in FIG. 28;

FIG. 30 is a plan view illustrating the inside surfaces of the panels of the package included in the delivery device shown in FIGS. 28 and 29;

FIG. 31 is an isometric view of the delivery device shown in FIGS. 28-30, with the package of the device being partially closed;

FIG. 19 is a plan view of a delivery device according to a third alternate embodiment of the present invention;

FIG. 33 is an isometric view of the delivery device shown in FIG. 19 with the included box partially closed;

FIG. 34 is a front elevation view of the delivery device shown in FIGS. 19 and 33, with the included box closed;

FIG. 35 is a front elevation view illustrating a delivery device according to a fourth alternate embodiment of the present invention;

FIG. 36 is a rear elevation view illustrating the delivery device shown in FIG. 35;

FIG. 37 is a side elevation view taken along line 37-37 in FIG. 35;

FIG. 38 is a side elevation view similar to FIG. 37, but with the bottom portion of the delivery device package being bent to provide access to the included data-encoded card;

FIG. 39 is a rear elevation view of the package included in the delivery device shown in FIGS. 35-38;

FIG. 40 is a block diagram illustrating a point of sale activated delivery system according to the present invention;

FIG. 41 is a block diagram further illustrating the point of sale activated delivery system according to the present invention;

FIG. 42 is a block diagram illustrating the various method steps according to the present invention.

FIG. 43 is a block diagram illustrating the general architecture of the point of sale activated delivery system of the present invention;

FIG. 44 is a block diagram illustrating various method steps according to the present invention;

FIG. 45 is a block diagram illustrating various method steps according to the present invention;

FIG. 46 is a block diagram illustrating various method steps according to the present invention; and

FIG. 47 is a block diagram illustrating various method steps according to the present invention.

FIG. 48 is a block diagram illustrating various method steps according to the present invention.

FIG. 49 is a block diagram illustrating various method steps according to the present invention.

FIG. 50 is a block diagram illustrating various method steps according to the invention.

FIG. 51 is a block diagram illustrating various method steps according to the invention.

FIG. 52 is a block diagram illustrating various method steps according to the invention.

FIG. 53 is a block diagram illustrating various method steps according to the invention.

### DETAILED DESCRIPTION OF THE INVENTION

The present invention provides various methods and devices for point of sale activated delivery of products or services for use in either a host to host transaction or with standard banking networks. More specifically, this invention provides activation of various products and services. In the following description, for purposes of explanation, numerous specific details are set forth in order to provide a thorough understanding of the present invention. It will be evident, however, to one skilled in the art that the present invention may be practiced without these specific details. In other instances, well-known structures and devices are shown in block diagram form in order to facilitate description. All patents referenced are incorporated by reference.

1. Definitions:

Activated Account. An activated account is an account that is activated upon reading a data encoded card with a point of sale terminal.

BIN (bank identification number). A BIN is issued by a bank for use in a transaction over standard banking networks.

Cartridge. Is a magnetic or optical disk for use in a Play Station® (Sony) or Nintendo® or the like.

Content. To include but is not limited to entertainment video and music, software file, executable file, encrypted key, fractional services of any kind.

DVD. Digital Video disk.

DISK. A magnetic or optical storage means for content.

IEMA. (Interactive Entertainment Merchants Association). An association of merchants that create retail packaging requirements for entertainment content.

HARD DISK CARD A card that includes a hard disk. These cards includes five megabits of interactive, re-writable and encrypted storage. See e.g. UltraCard® (Ultra Card, Inc.) (See e.g. Smith, Sr. U.S. Pat. No. 6,131,816).

Host to Host Transaction. Is a transaction between a consumer and a provider.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

HTTP (HyperText Transfer Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

ISBN (International Standard Book Number). A numerical identifier associated with books, pamphlets, educational kits, microforms, CD-ROM and Braille publications in circulation throughout the world. The ISBN is a ten-digit number assigned to each published title that provides an unduplicated, internationally recognized “identity.” The ISBN number can be a product code.

Metered Account. An account where a certain predetermined value is debited from the amount of goods and services provided as they are purchased.

MPEG (Moving Pictures Experts Group). The MPEG standard concerns high-quality coding of possibly interlaced video, including high definition television (HDTV). A wide range of applications, bit rates, resolutions, signal qualities and services are addressed, including all forms of digital storage media, TV broadcasting and communications.

PAN (Personal Account Number). A PAN number can be an alphanumeric data of any length. A PAN is a term transnational platforms use for host to host transactions. The PAN can include a provider code, product code and activation code.

PIN (Personal Identification Number). A PIN number can be alphanumeric data of any length. The PIN number correlates with a specific file and can also correlate with a specific transaction. The PIN can include a provider code, product code and activation code.

Point of Sale (POS) terminals. POS terminal devices are used by a merchant to process a transaction. These terminals can include a magnetic card reader for processing PIN and PAN information, a keypad for selecting options, entering transaction amounts, a display to report progress of a transaction and print a receipt and a device reading data encoded on a smart card or hard drive cards.

Provider. Is, for example, a publisher providing content like computer software, video games, music, CDs or DVDs, such as MTV®. A provider provides goods and/or services.

SMART CARD. An electronic or computer chip is added to the magnetic stripe on either side of the card, to provide additional data capacity (generally providing 2KB in data storage capacity).

Transaction Manager. Is a site controller connected to the POS terminal device via any communications link.

URL (Uniform Resource Locator). A unique address which fully specifies the location of a file or other resource on the Internet. The general format of a URL is protocol://machine address: port/path/filename. The port specification is optional, and if none is entered by the user, the browser defaults to the standard port for whatever service is specified as the protocol.

Web Site. A computer system that serves informational content over a network using the standard protocols of the World Wide Web. Typically, a Web site corresponds to a particular Internet domain name. As used herein, the term is generally intended to encompass both (i) the hardware/software server components that serve the informational content over the network, and (ii) the “back end” hardware/software components, including any nonstandard or specialized components, that interact with the server components to perform services for Web site users.

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

2. Overview of the System Components and Operation:

Any provider with billing and collections can make use of this system. For example, a retail store, such as Sears, can connect via an electronic communications link with a transaction manager or directly to a provider. This electronic communication is made using a POS terminal device. The transaction manager is a central processor that receives both data directly or indirectly from a POS terminal device. The transaction manager activates an identification number (PIN or PAN) in response to a request from a POS terminal device. With this active identification number the consumer can obtain various products and services. The products and services that can be managed with this system include, but are not limited to, for example: software, programs, music programming, television programming, literature, video games, extended warranty services, prepayment of insurance and prepayment of utility payments.

Referring now to the drawings, FIGS. 1-1 illustrate a delivery device 10, according to a first embodiment of the present invention, which may be used in the system of the present invention for the activated delivery of products and services. The delivery device 10 includes a package 12, a content storage device 14 retained by the package 12, and a data-encoded card 16 which is secured to the package 12. In the illustrative embodiment, the content storage device 14 comprises an optical disk. However, as subsequently discussed, the content storage device may comprise a wide variety of other devices. The particular details of the data-encoded card 16, as well as possible alternatives, will also be discussed subsequently.

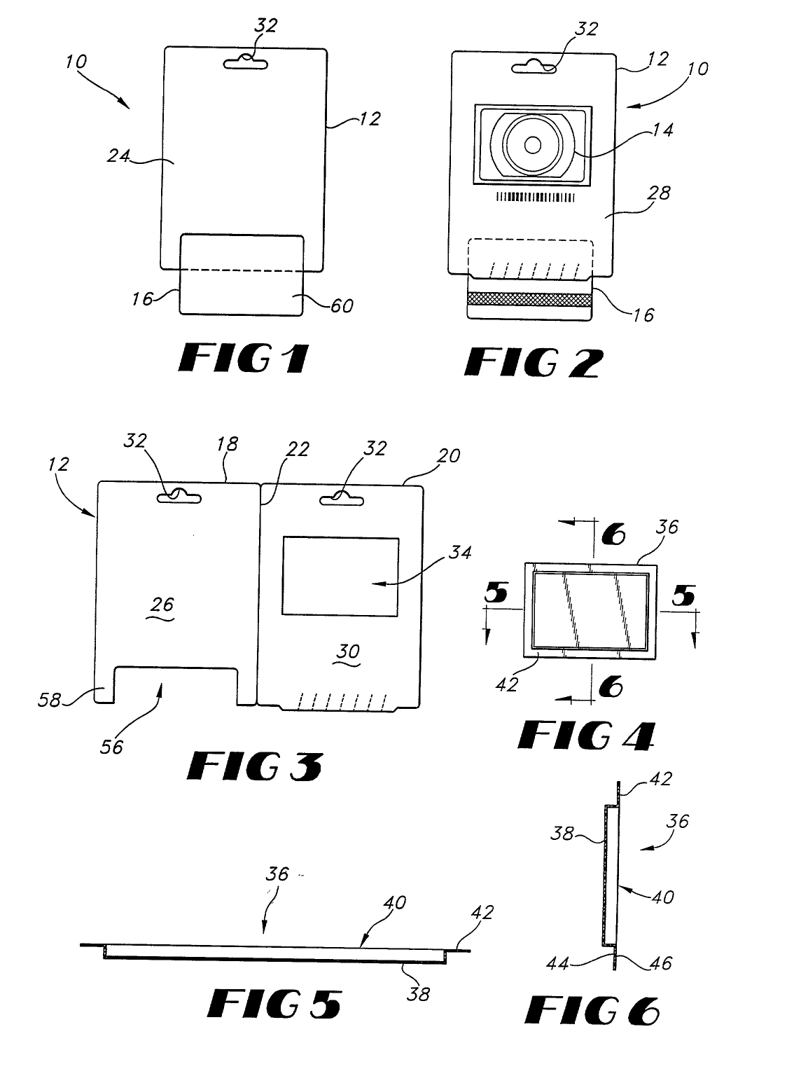

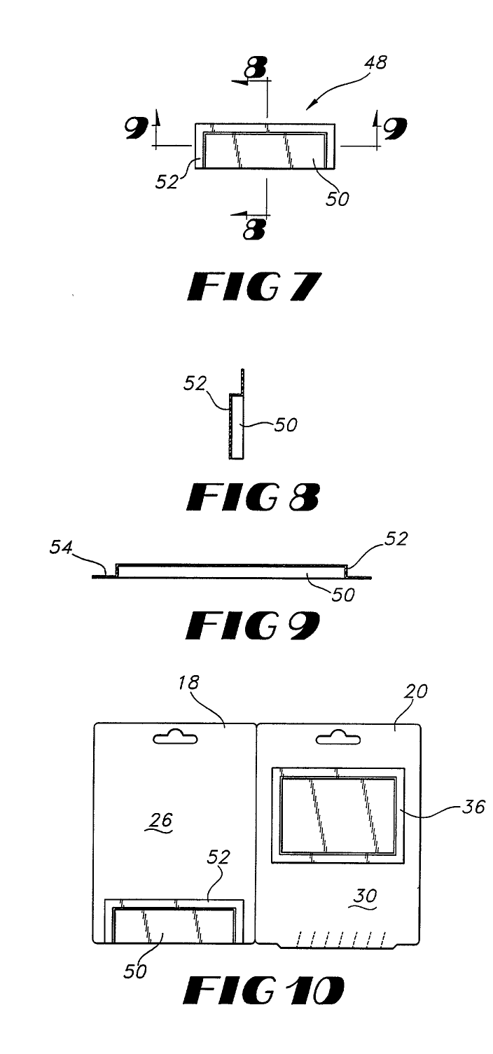

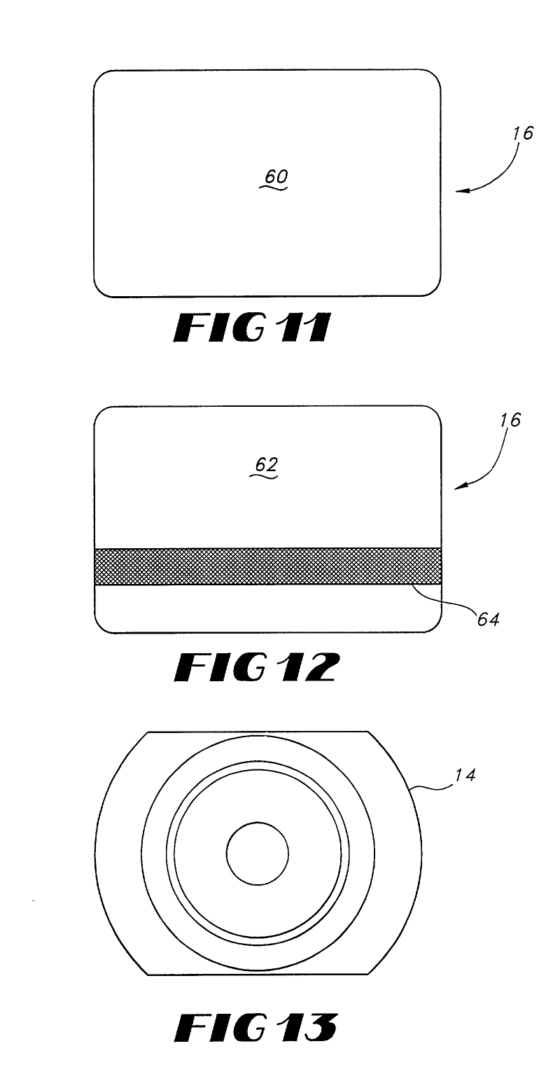

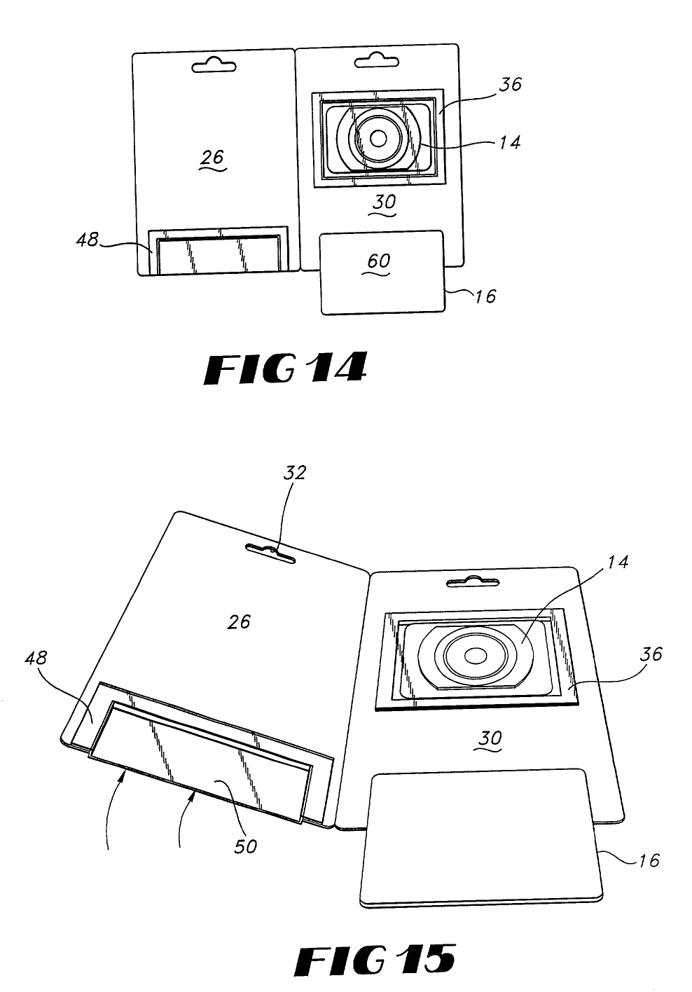

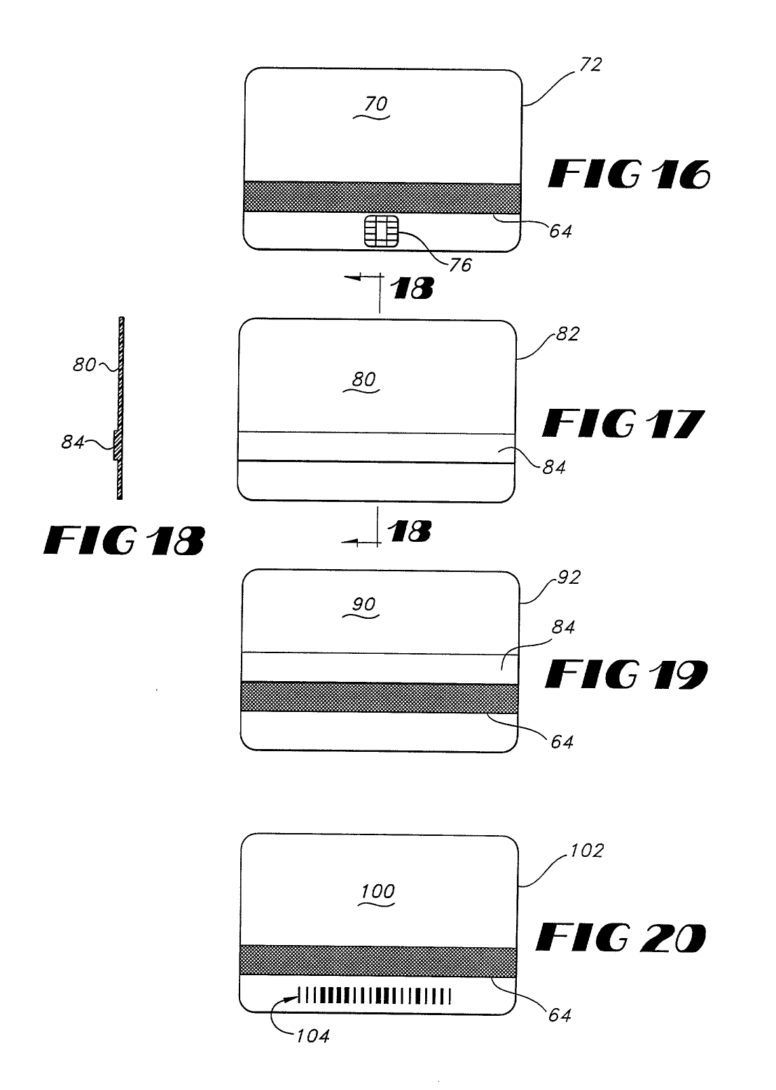

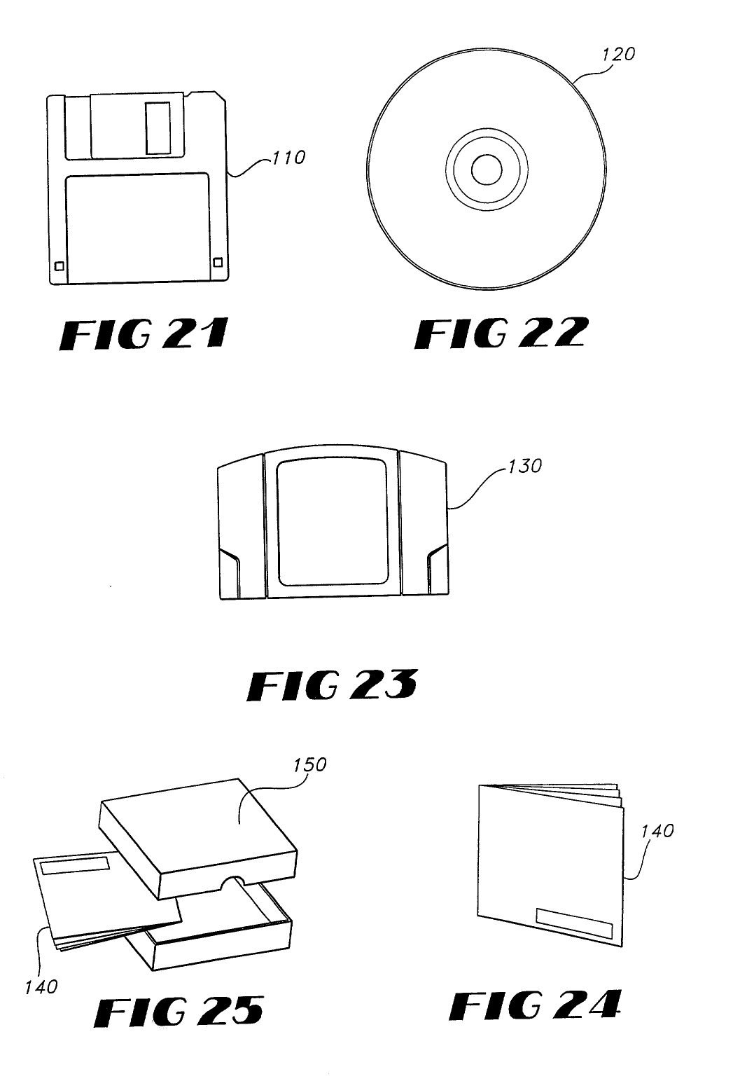

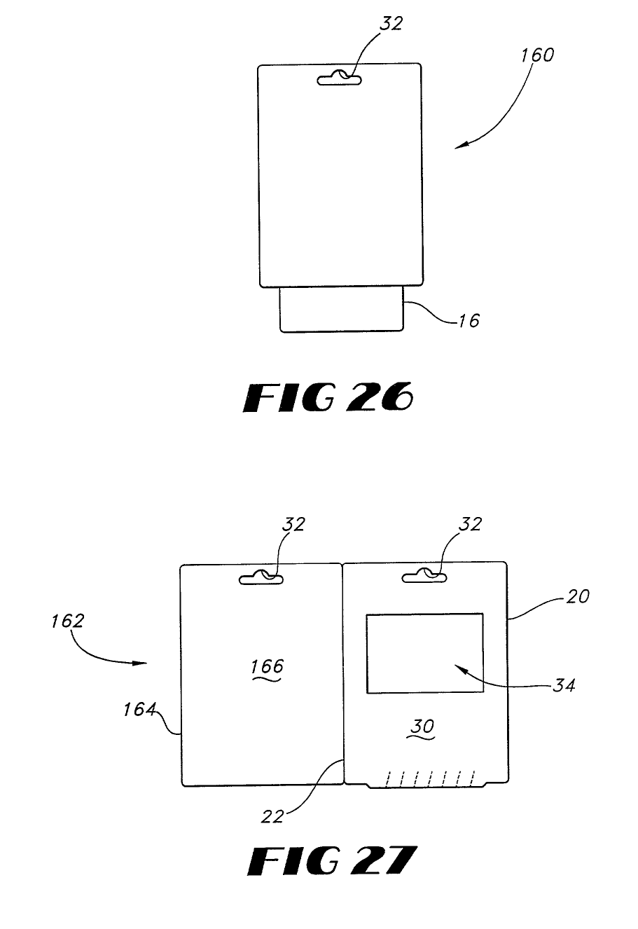

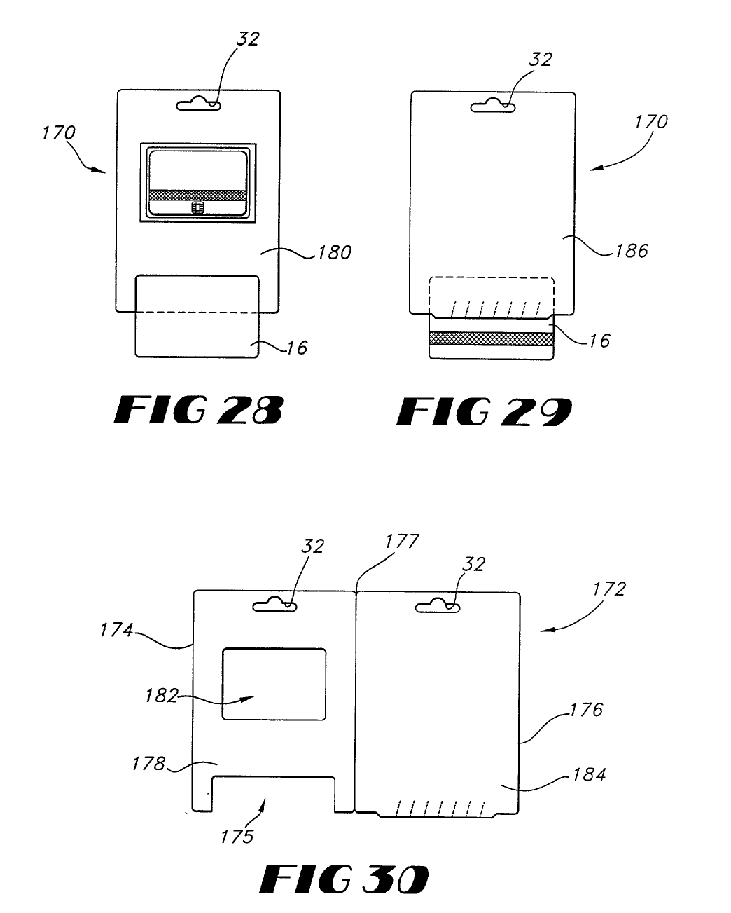

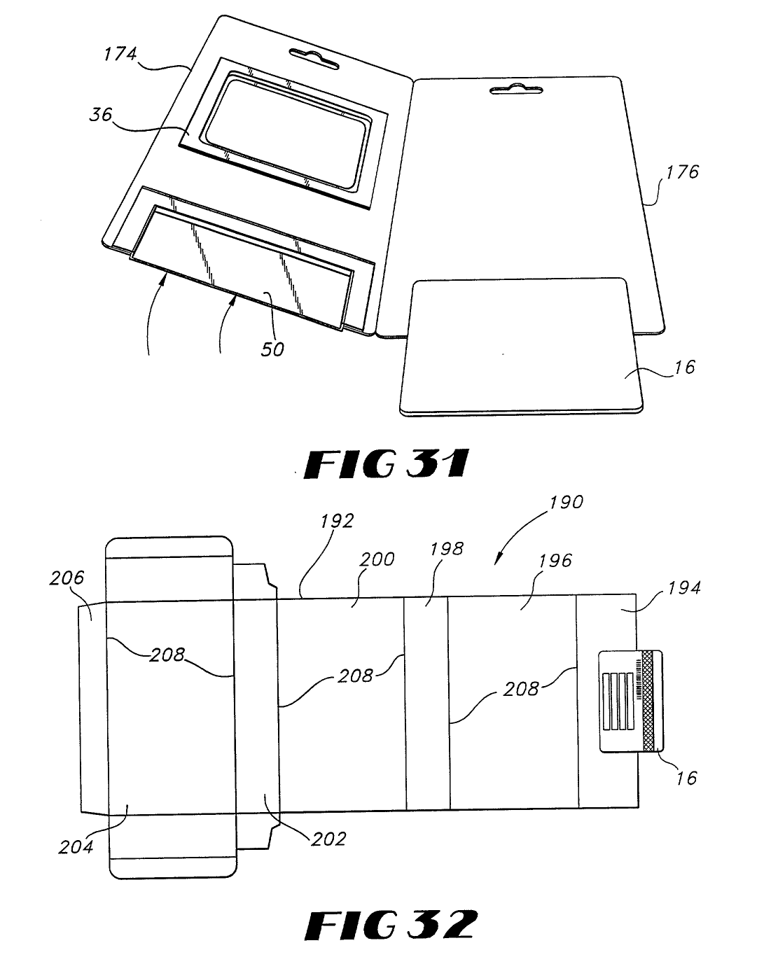

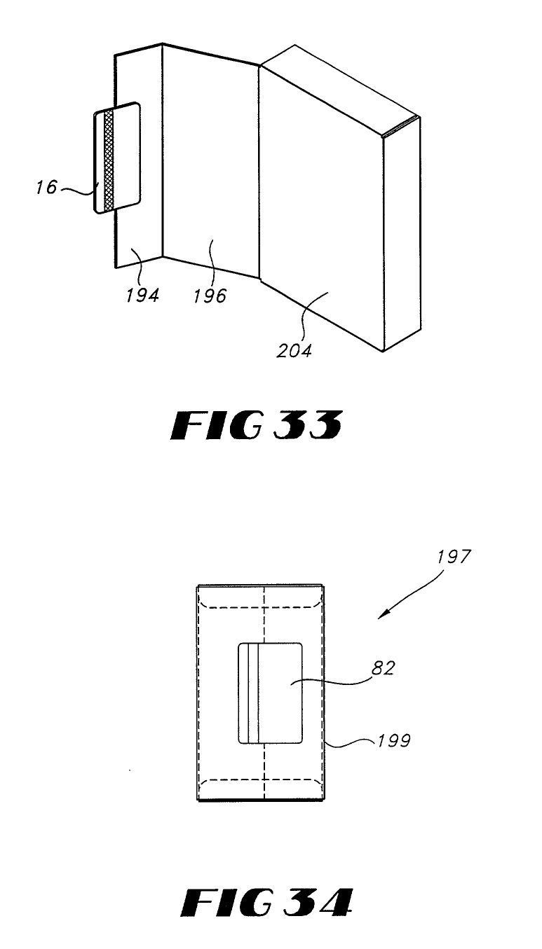

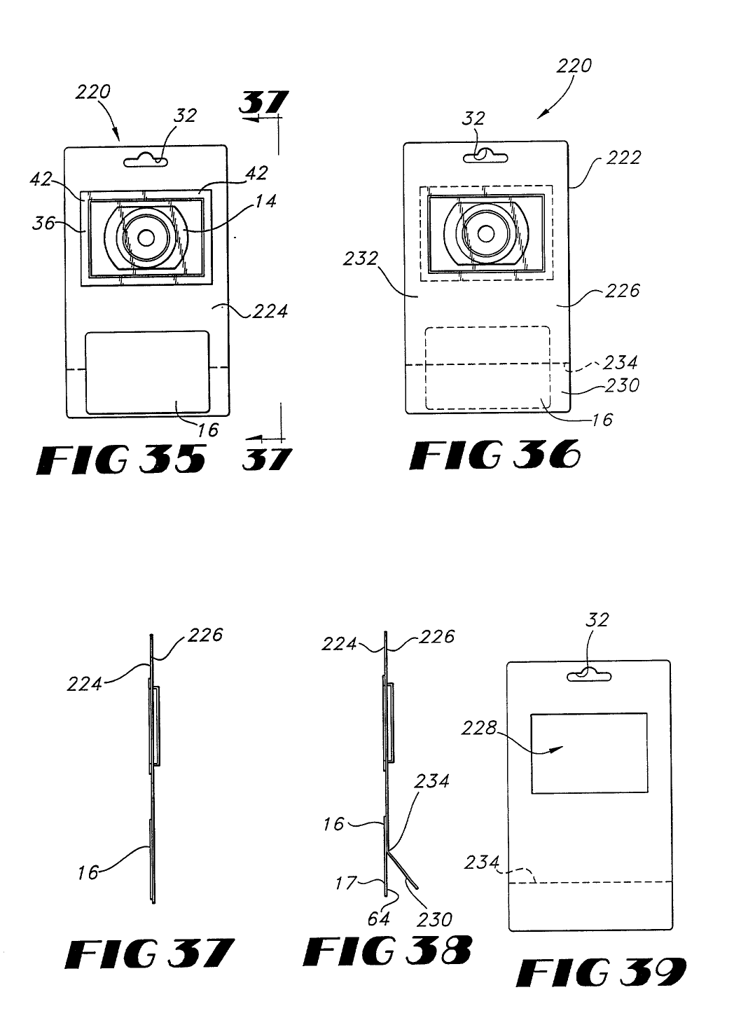

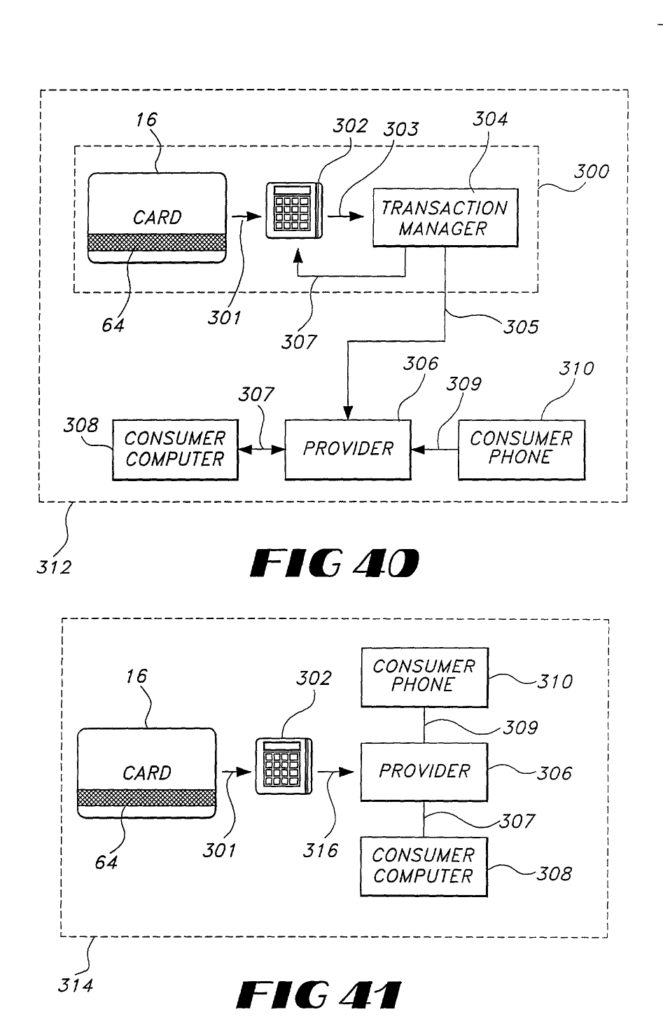

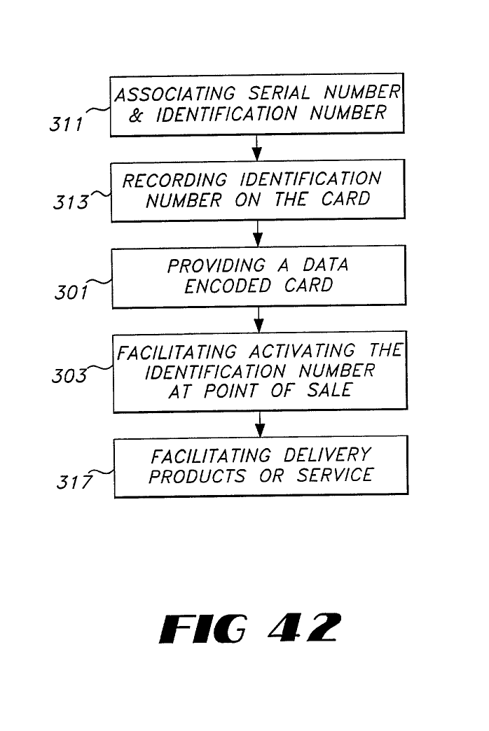

The package 12 of delivery device 10 includes a first panel 18 and a second panel 20 which are attached to one another. The panels 18 and 20 may be made of paper, paperboard and various composite materials or the like. The package 12 includes a scored interface 22 disposed between the first 18 and second 20 panels which facilitates folding one of the panels on top of the other, as subsequently discussed in conjunction with FIG. 1. FIG. 1 is a front view of delivery device 10 and FIG. 2 is rear view of the delivery device 10, with the device 10 being closed in both of these figures. In contrast, FIG. 3 is a view of package 12, in an open position. Panel 18 of package 12 includes an outside surface 24, shown in FIG. 1, and an inside surface 26, shown in FIG. 3. When the delivery device 10 is assembled, the outside surface 24 corresponds to a front surface. Similarly, the panel 20 of package 12 includes an outside surface 28 shown in FIG. 2, which corresponds to a rear surface when the delivery device 10 is assembled, and an inside surface 30 shown in FIG. 3.

Panels 18 and 20 each include an aperture 19 formed in an upper portion of the corresponding panel. As shown in FIGS. 1 and 2, the pair of apertures 19 are aligned with one another when the delivery device 10 is in an assembled condition as shown in FIGS. 1 and 2. Accordingly, the apertures 19 are effective for receiving a rod or the like used to support and display the delivery device 10, for instance in a retail store or the like. Although the shape of the apertures 19 shown in FIGS. 1-3 may be advantageously used for this purpose, it should be understood that apertures 19 may assume a wide variety of other shapes, including circular or hooked, within the scope of the present invention.

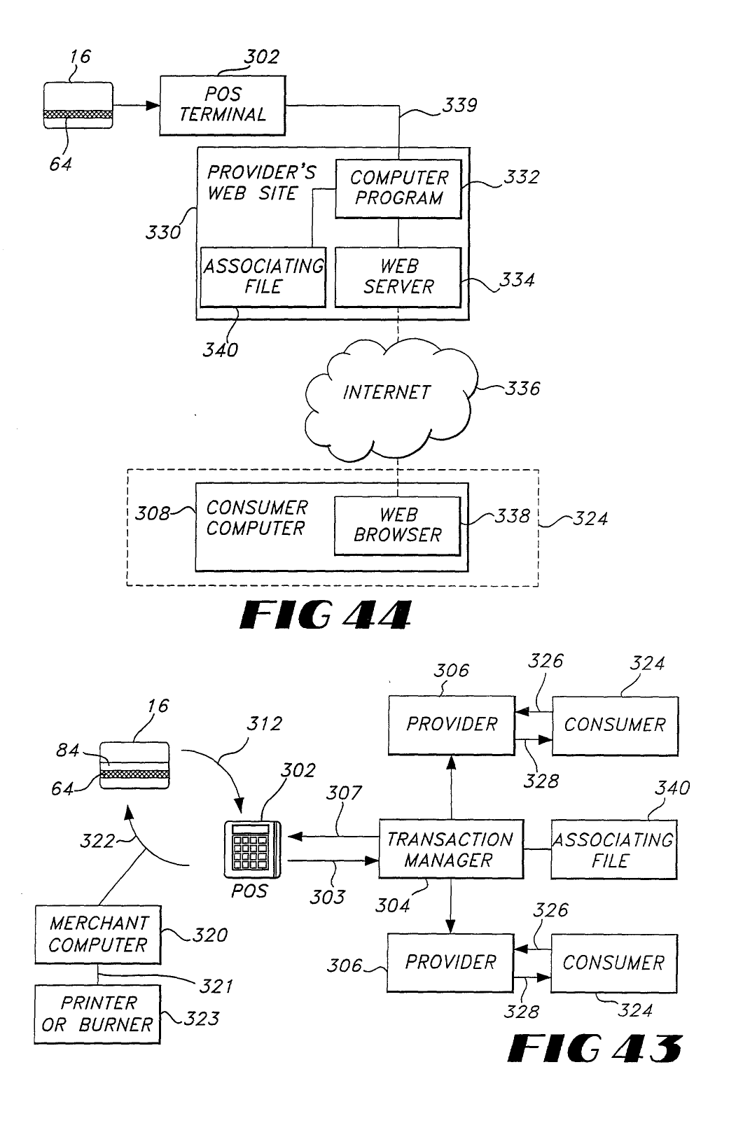

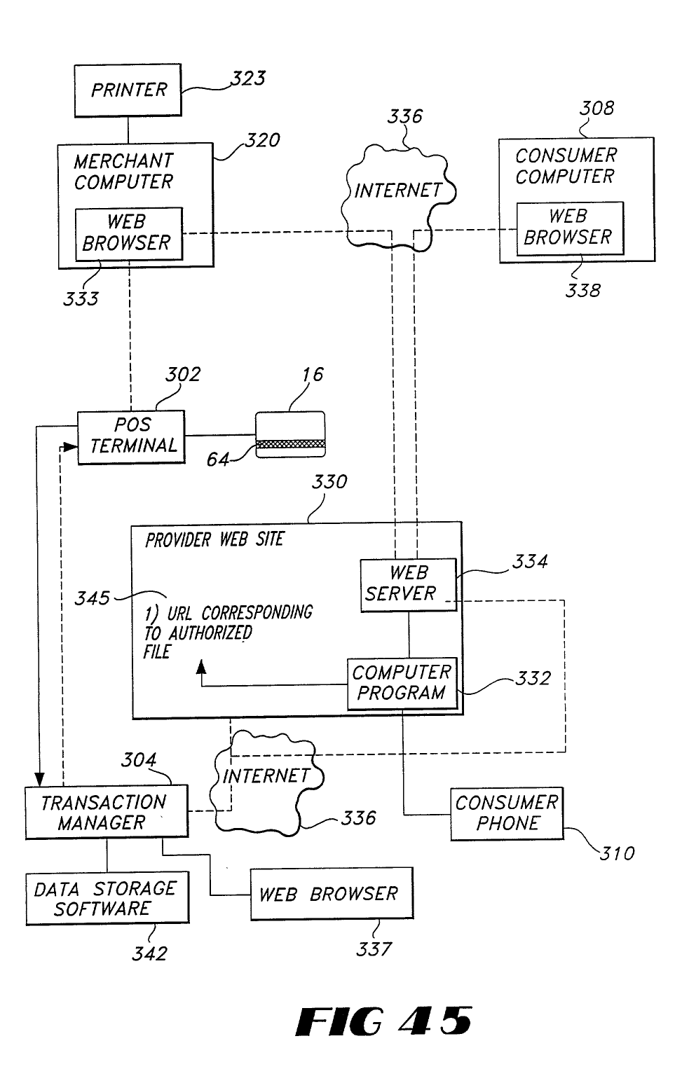

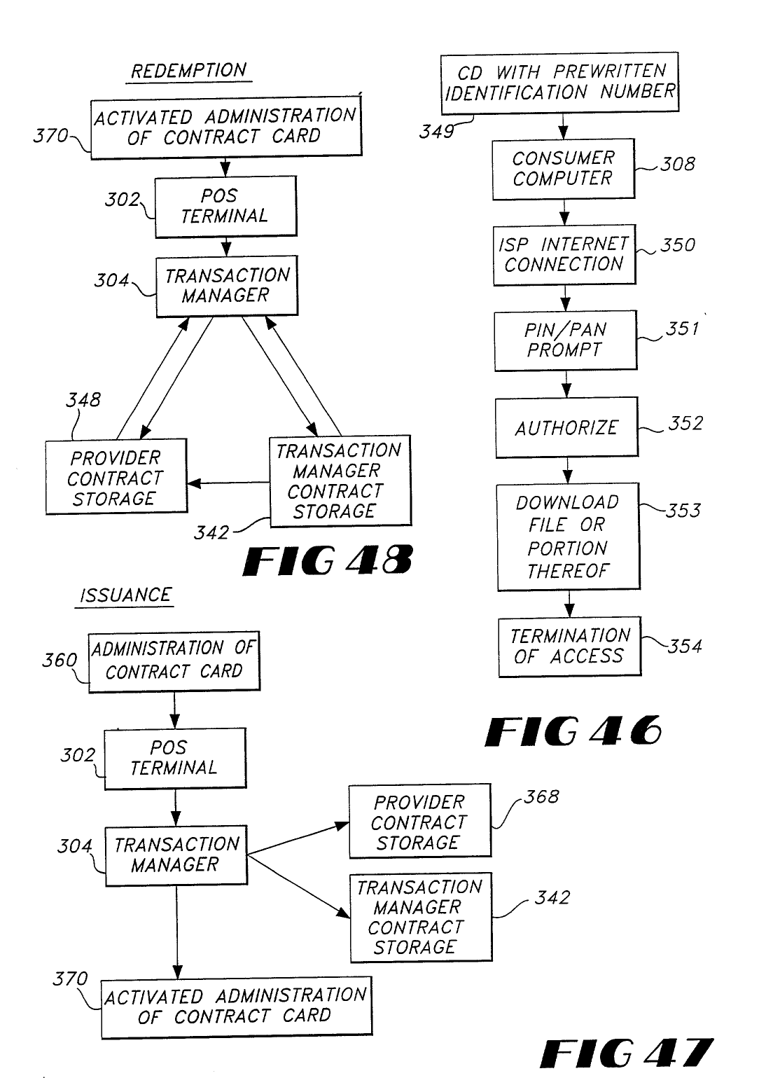

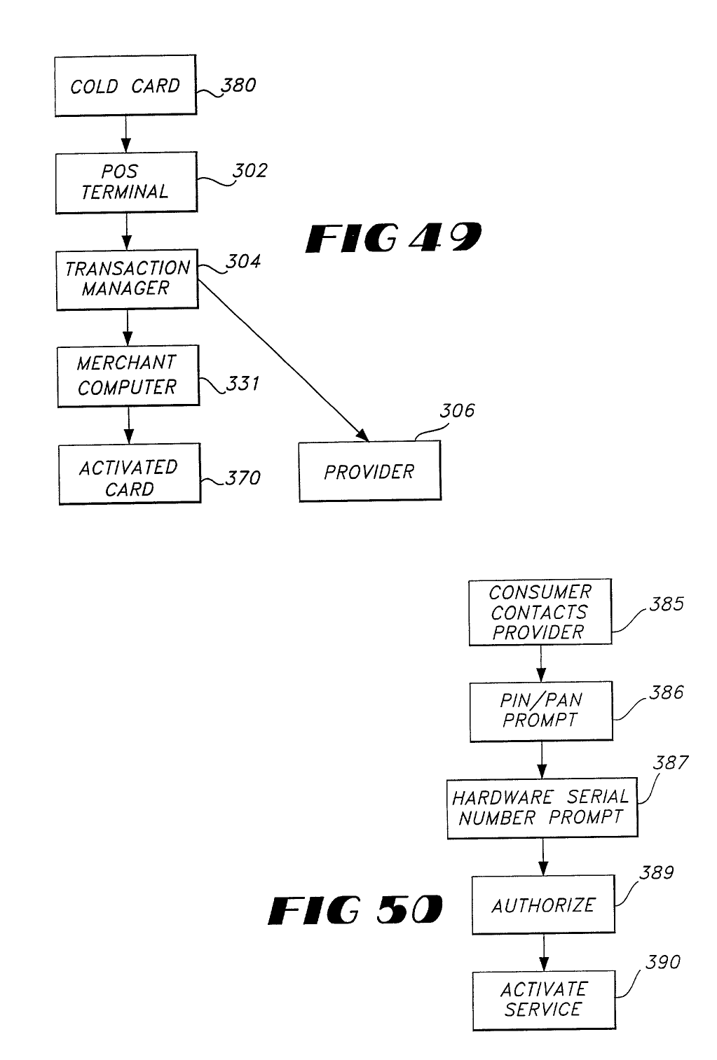

Panel 20 of package 12 includes an aperture 34 formed therein which extends through panel 20 and is effective for receiving an insert 36, which is illustrated in FIGS. 4-6. In the illustrative embodiment, the aperture 34 has a substantially rectangular shape. However, aperture 34 may assume other shapes, provided that the shape of the aperture 34 is complementary to the shape of insert 36. The insert 36 is made of a light-transparent material such as various clear plastics. The insert 36 includes a container portion 38 having an open top 40 and a peripheral flange 42 integral with the container portion 38 adjacent to the top 40. The flange 42 includes first 44 and second 46 surfaces. In an assembled condition, the surface 44 of flange 42 is secured, preferably by bonding, to the inside surface 30 of panel 20, with the container portion 38 of insert 36 protruding through the aperture 34 in panel 20 and beyond the outer surface 28 of panel 20. Alternatively, the container portion 38 could be substantially flush with the outside surface 28 of panel 20. FIG. 10 illustrates the insert 36 assembled to panel 20.

The package 12 of device 10 further includes a window 48 having a pane 50 and a frame 52 integral with the pane 50. The frame 52 is secured, preferably by bonding, to the inside surface 26 of panel 18. More particularly, a surface 54 of frame 52 is preferably bonded to surface 26 of panel 18. In the assembled condition, as shown in FIG. 10, pane 50 extends across a notch 56 formed in a lower portion 58 of panel 18. The window 48 is made of a various clear plastics, such as rigid vinyl or Mylar™ (DuPont, Wilmington, Del.) and accordingly, at least a portion of the front surface 60 of the data-encoded card 16 is viewable from a position exterior of the delivery device 10, through pane 50. The front surface 60 of the card 16 may be imprinted with a wide variety of marketing information, including various graphics, or alternatively, may be substantially plain . FIG. 10 illustrates the window 48 secured to panel 18 of package 12.

The data-encoded card 16 further includes a rear surface 62 and a data-containing portion 64 which is readable by a point of sale terminal device, as subsequently discussed in greater detail. This may be accomplished by a clerk at a checkout lane in a retail store, for instance. In the illustrative embodiment, the data-containing portion 64 comprises a magnetic stripe which includes at least one unique identification number. The magnetic stripe 64 may be laminated onto the rear surface 62 of card 16. Alternatively, the magnetic stripe 64 may be rolled onto the rear surface 62 of card 16. In yet other embodiments, the magnetic stripe 64 may be rolled or laminated onto a front surface 60 of card 16.

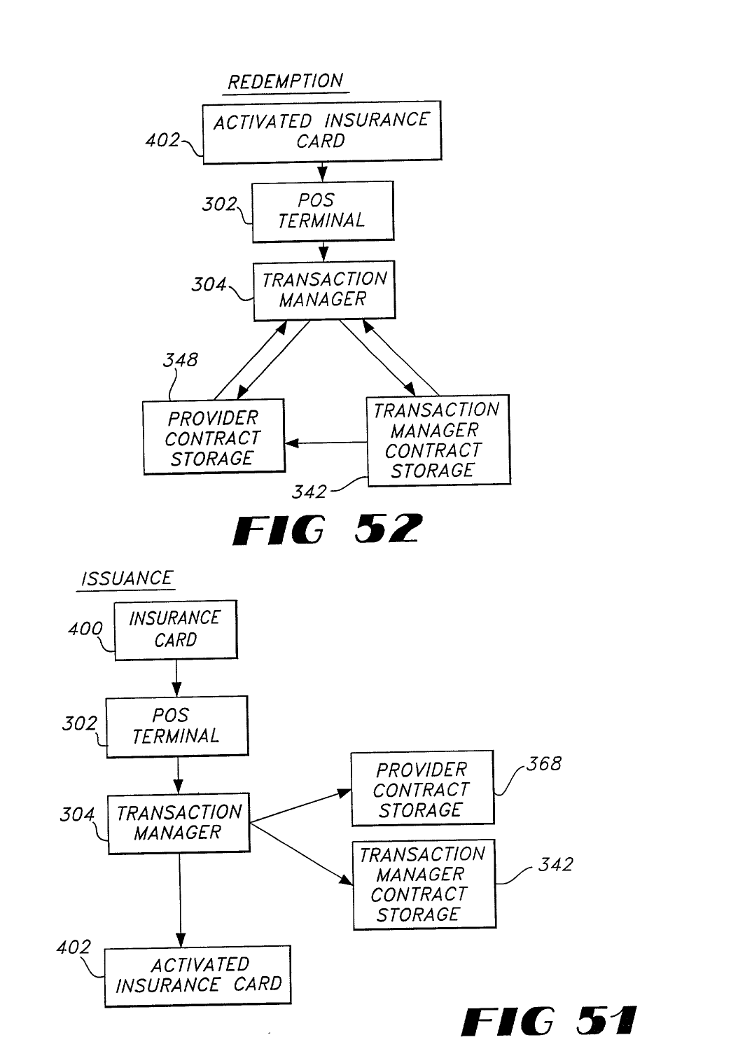

FIG. 14 illustrates the card 16 secured, or attached to the inside surface 30 of panel 20 of package 12. This is preferably accomplished by bonding a top portion of the rear surface 62 of card 16 to the surface 30 of panel 20 of package 12. When this is done, a lower portion of the card 16 protrudes below the package 12 as shown in FIGS. 14 and 1 which illustrate the delivery device 10 in an open and partially closed position, respectively. Accordingly, the magnetic stripe 64 of card 16 is disposed below package 12 and is therefore readable by a point of sale terminal device. FIGS. 14 and 1 also illustrate the content storage device 14, which comprises an optical disk in the illustrative embodiment, disposed within the insert 36. The optical disk 14 is also shown, in an enlarged view, in FIG. 13.

The data-containing portion 64 of card 16, which comprises a magnetic stripe in the illustrative embodiment, provides a PIN or PAN number. The PIN or PAN number is referred to as an identification number. The identification number correlates with the serial number of the product or service to be delivered. The identification number is in the format of a PIN or PAN, depending on the transaction manager. The format usually contains 16 to 26 digits but can go as high as the encoding manufacturer will allow. The identification number is unique to each card 16, but more than one identification number can be included on a card. The identification number is associated with a file maintained by the transaction manager 304 or the provider 306 as shown in FIG. 40. The identification number can also be associated with a control number. The control number can be added to the data encoded portion for additional security, by way of a bar code. The identification number is associated with a control or serial number of a product during the manufacture or is associated with a particular service. The identification number is recorded on the card on the data encoded portion of the card. The data encoded on the card may also identify the product or service delivered, identify the provider or direct the transmission of this identification number to the provider or transaction manager. In one embodiment, a control number is associated with the identification number and both numbers are required to be provided to the processor. The control number can be printed on the card or package. The identification number can be obscured.

The card 16 can be made of plastic, paper or a composite material. The card 16 can be of any shape, but rectangular is the preferred shape. The card 16 can be permanently attached to the package 12, as discussed previously, as it may or may not be needed after it is scanned at the point of purchase. The card 16 can include the telephone number or web address to facilitate delivery of the product or service. The identification number can be encoded on the magnetic stripe 64, as discussed previously, or can be encoded as a bar code or embossed or printed on the surface of the card 16 in numerals, or provided by any other means known in the art. In the preferred embodiment, if the identification number is printed on the card 16, it is obscured from view while the delivery device 10 is on display and the package 12 of device 10 includes a tamper evident device such as commonly used scratch-off labels to prevent someone from observing the identification number.

FIG. 16 illustrates a rear surface 70 of an alternative data-encoded card 72, according to the present invention. The front surface (not shown) of card 72, may be the same as card 16 discussed previously. Card 72 includes a first data-containing portion 64 which comprises a magnetic stripe in the illustrative embodiment and contains encoded data as described previously with regard to stripe 64 of card 16. Card 72 further includes a second data-containing portion comprising a smart chip 76, which is secured to the rear surface 70 of card 72. Both the magnetic stripe 64 and smart chip 76 may be exposed at a point of sale terminal for reading. The portion of the card including or containing the encoded data can be referred to as the data encoded portion 64.

FIG. 17 illustrates a rear surface 80 of another alternative data-encoded card 82 which includes a hard drive 84 secured to the rear surface 80 of card 82. Card 82 includes a front surface (not shown) which may be the same as card 16 discussed previously. Accordingly, the card 82 may comprise an Ultracard®, which can be used for point of sale generated access to remote files in the same way that a magnetic stripe such as magnetic stripe 64, is used to encode the desired data.

FIG. 19 illustrates a rear surface 90 of another alternative data-encoded card 92 having a front surface not shown which may be the same as that discussed previously with regard to card 16. The data-encoded card 92 includes a first data-containing portion 64, comprising a magnetic stripe, as discussed previously with respect to cards 16 and 72. Card 92 further includes a second data-containing portion 84 comprising a hard drive, as discussed previously with respect to card 82. Both data-containing portions, i.e., magnetic stripe 64 and hard drive 84 can be exposed at the point of sale for reading. Additionally, the second data-containing portion may alternatively comprise any known means to encode data, in lieu of the hard drive 84.

The additional data-containing portions discussed previously, i.e., smart chip 76 of card 72 or hard drive 84 of card 92, can provide the following information, depending upon storage capacity: licensing documents including a license number; serial number; a copy of the license and/or the desired software, music or literature itself.

FIG. 20 illustrates a rear surface 100 of yet another alternative data-encoded card 102 which includes a front surface (not shown) which may be the same or different than the front surface 60 of card 16 discussed previously. Card 102 includes a first data-containing portion comprising a magnetic stripe 64 which is secured to the surface 100, as discussed previously with respect to card 16. Card 102 further includes a barcode, indicated at 104, which is imprinted on the rear surface 100 of card 102. The barcode 104 can provide an identification number. The barcode 104 can be used with multiple packs of cards or for security reasons

FIGS. 21-25 illustrate a variety of alternative content storage devices which may be disposed within the insert 36 of package 12 of delivery device 10, in lieu of the optical disk 14 discussed previously. More particularly, FIG. 21 illustrates a computer diskette 110. FIG. 22 illustrates a compact disk 120 which may contain music thereon or a variety of other information. FIG. 23 illustrates a game cartridge, which may comprise a Nintendo® game cartridge 130 for instance. FIG. 24 illustrates a book 140 and FIG. 25 illustrates a box 10 containing the book 140.

FIG. 26 is a front view illustrating a delivery device 160 according to a second embodiment of the present invention. The delivery device is the same as device 10 except as subsequently discussed. The device 160 includes a package 162, in lieu of package 12 of device 10. The package 162 includes a panel 20, which is the same as that used in package 12, with panel 20 including an inside surface 30 and an aperture 19 formed therein for the previously discussed purpose. Package 162 also includes a panel 164 having an inside surface 166, with the panels 164 and 20 being secured to one another along a scored interface 22. As shown in FIG. 27, the panel 164 differs from panel 18 of package 12 since the panel 164 does not include a notch 56 formed in a lower portion thereof, and does not include the window 48. Accordingly, when the package 162 is closed and the delivery device 160 is assembled as shown in FIG. 26, an upper portion of the card 16, which is secured to panel 20 as discussed previously with respect to package 12, is obscured from view from a position exterior of the package 160. In this embodiment, it should be understood that any of the previously discussed alternative data-encoded cards, i.e., cards 72, 82, 92 and 102, may be used in lieu of card 16. Furthermore, that multiple cards may be included in a package with a content storage device.

FIGS. 28-31 illustrate a delivery device 170, according to a third embodiment of the present invention. The delivery device 170 includes a package 172 having a first panel 174 and a second panel 176 which are secured to one another from a scored interface 177. The panel 174 includes an inside surface 178 and an outside surface 180, which comprises a front surface when the delivery device 170 is assembled. Similarly, the panel 176 includes an inside surface 184 and an outside surface 186, which comprises a rear surface when the delivery device 170 is assembled. As shown in FIGS. 28, 29 and 31, a data encoded card 72 or 82 is secured to the panel 176 in the same manner as discussed previously with respect to card 16 in package 12.

Like panel 20 of package 12 of delivery device 10, the panel 176 of package 172 includes an aperture 19 for the previously discussed purposes. However, panel 176 does not include the aperture 34 or clear plastic insert 36 which are included in panel 20 of package 12. Instead, the panel 174 includes an aperture 182 which is effective for receiving the insert 36, discussed previously. Also, the panel 174 includes a notch 175 formed in a lower portion thereof, which is effective for receiving the window 48 discussed previously with respect to package 12 of delivery device 10. As shown in FIGS. 28 and 31, one of the cards 16 is disposed within the insert 36. FIG. 31 illustrates the delivery device 170 in a partially closed condition.

FIGS. 19-33 illustrate a delivery device 190 according to a third embodiment of the present invention. The delivery device 190 includes a package 192 and, a data-encoded card 16 secured to the package 192. Alternatively, any of the alternative cards 72, 82, 92 and 102, discussed previously, may be used in lieu of card 16.

As best seen in FIG. 19, the package 192 includes a flap 194, a cover 196, a first side 198, a back 200, a second side 202, a front 204 and a tab 206, which may comprise a glue tab. The various portions of package 192 are secured to one another as shown in FIG. 19, with a scored interface 208 existing between each adjacent pair of elements or portions of the package 192, to facilitate folding the package 192 as illustrated in FIG. 33. This folding carton provides both activation means such as FIGS. 16, 17, 19 and 20 and storage area for content device such as FIGS. 21, 22, 23, 24, and 25.

FIG. 34 illustrates a delivery device 197 according to a fourth embodiment of the present invention. The delivery device 197 includes a package 199 and a data encoded card 82 or 92 as discussed previously.

FIGS. 35-39 illustrate a delivery device 220 according to a fifth embodiment of the present invention. The delivery device 220 includes a single panel 222 having a first, front surface 224 and a second, rear surface 226. Panel 222 includes one of the apertures 19, discussed previously with respect to package 12 of delivery device 10, formed therein for the purpose of receiving a rod or the like used to support and display the delivery device 220.

Panel 222 further includes an aperture 228 formed therein and extending therethrough, with the aperture 228 being effective for receiving the insert 36 as discussed previously with respect to package 12 of delivery device 10. In the illustrative embodiment, the frame 42 of insert 36 is secured, preferably by bonding, to the front surface 224 of panel 222.

The single panel 222 includes a lower portion 230, a remaining portion 219 and a laterally extending score 234 forming an interface between the lower portion 230 and the remaining portion 219. The data-encoded-card 16 is secured to the front surface 224 of the remaining portion 234 of panel 222. When the panel 222 is in a substantially planar position, i.e., when panel 222 is not bent as shown in FIG. 37, panel 222 extends below the card 16. Due to the presence of the laterally extending score 234, the lower portion 230 of panel 222 is bendable away from the data-encoded card 16 to reveal a lower portion 17 of the card 16, so that the data-containing portion 64 may be read by a point of sale terminal. It should be understood that any of the alternative data-encoded cards discussed previously, i.e., cards 72, 82, 92 and 102 can be used in lieu of card 16. Furthermore, this invention provides that multiple cards may be included in a package with a content storage device.

With reference to FIG. 40, a system for activated delivery of products and services is shown. The system for activated delivery of products and services 300 is made of a card 16 with a data encoded portion 64, such as a magnetic strip, a point of sale terminal 302, and a transaction manager 304. The data encoded card 16 encodes a unique identification number facilitating the delivery of products or services. In an alternative embodiment, the delivery system 300 additionally includes a provider 306 and a consumer computer 308 or a consumer phone 310. The data encoded card 16 can optionally be attached or enclosed in a package 12 as previously shown.

The POS terminal device 302 is linked 303 by any form of electronic communication with the transaction manager 304. The transaction manager 304 is linked 305 by any form of electronic communication with a provider 306. The transaction manager 304 administers the delivery of products or services through a POS terminal device 302. When the data encoded card 16 is read by the point of sale terminal 302, the transaction manager 304 authorizes the delivery of the products or services to a consumer by activating the identification number encoded on the data encoded portion of card 16. The consumer can provide the activated identification number to the provider 306 to facilitate the delivery of products or services, using a computer 308 or phone 310.

In the alternative delivery system shown in FIG. 41, a system 314 is made of a card 16 with data encoded portion 64, such as a magnetic stripe, a POS terminal device 302 and a provider 306 is shown. The data encoded card 16 can be optionally attached or enclosed in a package 12 as previously shown. The provider 306 administers the delivery of a product or a service through a POS terminal device 302. When the data encoded card 16 is read by POS terminal device 302, the provider 306 authorizes the delivery of products or services to a consumer by activating the identification number encoded on the data encoded portion of the card 16. The consumer can provide the activated identification number to the provider 306 to facilitate the delivery of the products or services using a computer 308 or phone 310. This delivery system 314 is referred to as host-to-host connection.

Now referring to FIG. 40-42, a general method of point of sale activated delivery of products and services is shown. This method involves providing 301 a data encoded card, the data including an identification number, facilitating 303 the activation of the identification number at the point of sale 302. The activation of the identification number can be facilitated by providing 303 the identification number from the POS terminal device 302 to the transaction manager 304, or in an alternative embodiment, by providing 316 the identification number from the POS terminal device 302 to the provider 306.

This method further involves facilitating 317 the delivery of products or services associated with the identification number. The delivery of the products or services can be facilitated by providing a consumer with a data encoded card 16 having an activated identification number. A consumer with this active identification number can facilitate 317 the delivery of the purchased products or services by providing the active identification number to the provider 306. The consumer can request delivery of the products or services by providing the active identification number to the provider 306. The active identification number can be provided using any means of electronic communications 307 between a consumer computer 308 and the provider 306 or by the consumer providing 309 the active identification number using a phone 310.

More specifically, referring to FIG. 42 with respect to the delivery of a product, a serial number of the product is associated 311 with the identification number during the manufacture of the product. The identification number is recorded on a card to provide a data encoded card 16.

The consumer can be provided with the identification number in a variety of ways. The identification number can be printed on the card, the identification number can be provided on the receipt or the identification number can be pre-written on a content storage device. The consumer can provide the active identification number to the provider 306 by transmitting 307 the active identification number by a consumer computer 308 or by transmitting 309 the active identification number by a consumer phone 310. In response to receiving the active identification number, the provider 306 authorizes the delivery of the products or services associated with the active identification number.

In an alternative embodiment shown in FIG. 43, the card 16 includes a data encoded portion capable of receiving information 84. More specifically, cards 16 are issued for a particular type of service or product. For example, a consumer buys a phone card. The data encoded portion 64 is pre-encoded with a code associated generically with phone service. The data encoded portion of card 16 is read with a POS terminal device 302. The transaction manager 304 receives a request 303 from a POS terminal device 302 for an identification number. The transaction manager 304 creates an association or associating file 340. This associating file 340 can include the serial number of the product, the identification number, a vendor code or any desired information. The transaction manager 304 transmits 307 an active identification number to the POS terminal device 302 which in turn is in communication with a device, such as computer 320, that writes or encodes 322 the active identification number to data encoded portion 84 of the card 16, or in the alternative embodiment, the POS terminal device 302 encodes the information. The consumer 324 can then by any form of electronic communication contact 326 a provider 306. The provider 306 then delivers 328 the purchased goods or services by any form of electronic communication.

Still referring to FIG. 43, the data encoded portion can be encoded on a hard drive or computer chip affixed to the card. The hard drive or computer chip can be read by the POS terminal device 302 or by a connection 322 to the merchant computer 320 and a connection 321 to a printer or burner 323 can be provided information, depending on the storage capacity. The information encoded includes but is not limited to licensing documents, including license number, serial number, a copy of the license and if desired the software, music or literature itself. More specifically, a point of sale terminal 302 upon receiving an active identification number from the provider 306 or transaction manager 304 can be directly in electronic communication with a printer or burner 323 or indirectly in communication with a printer or burner 323 through a merchant computer 320. The POS terminal device 302, in response to receiving the active identification number, can print the identification number or any necessary information to complete the delivery of the products or services.

Additionally, the data encoded portion of the card 84 can encode licensing documents. In this method, the active identification number is provided to the POS terminal device 302. The POS terminal device 302 can, upon receiving the active identification number, facilitate the printing of the licensing documents for the consumer. Additionally, the POS terminal device 302 can, upon receiving the active identification number, facilitate a burner 323 to write a copy of software on to a content storage device.

Now referring to FIGS. 44-45, a general method to provide point of sale activated delivery of products or services using the Internet is provided. The data encoded on card 16 is read using a POS terminal device 302. The POS terminal device 302 is in electronic communication with the provider's computer program 332. The provider's computer program includes operating software that recognizes the identification number and activates the identification number. The provider's computer 332 creates an associating file 340 which correlates the product or service to be delivered and the associated active identification number. The consumer using consumer computer 308 using a standard web browser 338, such as Microsoft®'s Internet Explorer or Netscape®'s Navigator, uses the HTTP protocol to communicate via the Internet 336 with web server 334 of the provider's web site 330. The consumer can then via the Internet 336 provide the active identification number and request the delivery of products or services associated with the identification number from the provider 306. The provider 306 in response to receiving the active identification number delivers the requested products or services to the consumer.

More specifically, a method to provide a point of sale activated delivery of products or services using the Internet is provided. Referring to FIG. 45, the data encoded card 16 is read using POS terminal device 302. The POS terminal device 302 transmits the data to the transaction manager 304 or alternatively, to merchant computer 320. The identification number can be transmitted from the transaction manager 304 via the Internet 336 to the provider's web server 334. The transaction manager 304 uses a standard web browser such as Microsoft's Internet Explorer or Netscape's Navigator, which uses the HTTP protocol to communicate with a web server 334 of the provider web site 330. In an alternative embodiment, the merchant's computer's web browser 333 can contact the provider's web site 330 using HTTP protocol to communicate with a web server 334 of the provider's web site 330.

In the preferred embodiment, POS terminal device 302 requests activation from transaction manager 304 via any communications link. The transaction manager 304 includes operating software that recognizes the identification number, activates the identification number and transmits the activated status of the identification number to the provider web site 330 or computer 332 and can, in one embodiment, simultaneously transmit the activated status for the identification number to POS terminal device 302. The transaction manager 304 records the identification number as being active in data storage software 342. Consumer computer 308 using web browser 338 connects with provider's web server 334 which requests the identification number (PIN or PAN). Consumer enters the active identification number. Provider's computer program 332 confirms and downloads content to consumer computer 308 via the Internet 336.

In one embodiment, the URL of the purchased computer software, video game, CD and/or DVDS purchased from the merchant and the identification number are encoded on a content storage device, such as an optical disk, during the manufacturing process. See e.g. Mages et al, U.S. Pat. No. 6,035,199 (hereby incorporated by reference). In an alternative embodiment, the computer program 332 associates the identification number with a specific product. The computer program 332 assigns a URL corresponding to the file 345. The computer program 332 via web server 334 notifies consumer computer 308 via web browser 338 of the URL of the product requested.

A feature of this invention is that, at the time of purchase, the delivery system is activated by a POS terminal device. A POS terminal device generally includes all data encoded readers capable of reading or writing information on a magnetic stripe, computer chip, hard drive, or barcode or the like. Hardware devices such as cash registers for credit or debit cards, such as VISA can be used to transmit data on standard banking channels. A device such as a Verifone® can be used to read a magnetic strip for use in a host-to-host transaction See, e.g. Rowlands, U.S. Pat. No. 6,126,073 (hereby incorporated by reference).

A feature of this invention is that at the time of purchase a hardware device, such as a POS terminal device, provides information to the provider. This information may include the ISBN of the material purchased, a provider number of the material purchased, the time of purchase and the amount of the purchase. This feature can provide the provider with real-time inventory numbers. Various methods may be used for the remote download of software. With respect to the download of files to an optical disk, a video program signal is converted to a digital format, and then compressed and encoded in accordance with one of several known compression algorithms or methodologies. This compressed digital system signal, or bitstream, which includes a video portion, an audio portion, and other informational portion, is then transmitted to a receiver. Transmission may be over existing television channels, cable television channels, satellite communications channels, and the like. A decoder is then typically employed at the receiver to decompress and decode the received system signal in accordance with the same compression algorithm used to encode the signal. The decoded video information may then be output to a display device, such as a television (TV) monitor. Video compression and encoding is typically performed by a video encoder. The video encoder normally produces a compressed digital system signal that conforms to a recognized standard or specification agreed to among the senders and receivers of digital video signals. One such standard is DVDS. It includes audio and video compression technologies, as well as provisions for other information streams. Decoding technology is known. See e.g. U.S. Pat. No. 6,076,062 issued to Van Steenbrugge and U.S. Pat. No. 6,160,953 (hereby incorporated by reference).

1. Musical, Video, and Literary Products

In the manufacture of musical or literary products recorded on an optical or magnetic disk, an association file with the serial number or random control number of a copy of the product is made with an identification number. The activated delivery system can be managed by either a transaction manager 304 or a provider 306. The transaction manager 304 or provider 306, upon receiving an identification number from a POS terminal device, activates the identification number which can be used to facilitate the delivery of a file or a portion of a file containing musical or literary products. A wide variety of methods can be used to deliver musical or literary content as will be discussed in the following examples. To better understand these examples, reference is made to FIGS. 45 and 46.

In one embodiment, a card is encoded with the identification number. The data encoded card 16 is read using a point of sale terminal 302. The identification number is transmitted to a transaction manager 304 that activates the identification number. The consumer loads a disk or cartridge into a computer 308 and selects either on-line activation or IVR (voice recognition) activation 310. IVR users call an 800 number, enters an activation number, and the provider 306 transmits an encrypted key to complete the installation of the musical or literary product. Similarly, an online consumer enters the active activation number, receives confirmation and the provider 304 transmits an encrypted key to complete the installation of the musical or literary product.

In another embodiment described in FIG. 46, an optical disk is pre-written with the identification number 349. When the disk is inserted into the consumer's computer 308, standard software will facilitate the loading of the software. Once a connection is made through the Internet 336 to the provider's web site 330, the consumer will be prompted for an identification number 351. Once the correct identification number is supplied, and the provider authorizes 352 the delivery of the product. The product or portion of the product (the entire file or special encrypted key) is then remotely downloaded 353 to either a magnetic or optical disk depending on the format. See e.g. Britt, U.S. Pat. No. 5,940,074 (hereby incorporated by reference). The authorization to download terminates 354 after the file or portion of the file is downloaded or remains active for a specified period and then terminates. If a computer with a disk containing an unauthorized identification number accesses the provider's web site, access will be denied because code on the identification number had not been activated at the point of sale.

In an alternative embodiment, if the product manufacturer wishes to use blank optical or magnetic disks the merchant's cash register could be provided with software that would provide the URL of the provider and the identification number to the consumer as part of the receipt at the point of sale, or if a magnetic stripe is used the POS terminal device can be in electronic communication with a computer and printer, and upon receiving the active identification number the printer can then print the activation number and URL of the provider.

More specifically, as shown in FIGS. 43, 45 and 46, in operation the merchant computer 320 transmits data obtained from the POS terminal device 302 to a provider's Web site 330 using a standard Web browser 333, such as Microsoft®'s Internet Explorer or Netscape®'s Navigator, which uses the HTTP protocol to communicate with a Web Server 334 of the provider Web site 330. The Web Server 334 contacts provider's computer program 332, which accesses a catalogue of documents that correspond to the identification number 345. The provider web server 334 send the merchant web browser, 333 via the Internet 336, the specific URL and the identification number 345 of the specific file. The merchant computer will print 323 the specific URL and identification number on the consumer's receipt.

Once a connection to the Internet 336 is obtained the consumer's web browser 338 will search for the specific active URL that correlates with the product purchased from the store. Once the ISP connection 350 is made to the designated URL location, the consumer will be prompted for an identification number 351. Once the correct identification number is supplied, the provider authorizes 352 the download of content. The product is then remotely downloaded to either a magnetic or optical disk depending on the format 353. See Britt, U.S. Pat. No. 5,940,074 (hereby incorporated by reference). The specific URL will remain active until the download is complete or will remain active for a specified period and then terminate.

In another alternative embodiment, referring to FIGS. 43, 45, and 46 for example, the identification number is embossed on the card 16, but the CD in the package 12 is blank. A card 16 having an identification number magnetically encoded and embossed on the card is swiped through POS terminal device 302. These data are simultaneously transmitted to provider web site 330 and transaction manager 304. The transaction manager 304 authorizes the download by activating the identification number. The transaction manager 304 communicates this authorization to provider's computer 332. The consumer will return home with the disk and insert the blank disk into his or her computer 308. Standard software will facilitate loading of the software. When a connection 350 to the Internet is obtained, the consumer 194 can access provider's web site 330. The consumer will be prompted for an identification number 351 and once the identification number is supplied from the embossed card, access to the associated file will be approved by the provider 352. The consumer can then download 353 the file to the disk by standard means.

For example, a retail store carries packages containing blank CDs and point of sale activated card with a data encoded magnetic strip. The packages depict an MTV® music program, such as a picture of the artist. The data encoded stripe has an identification number that correlates with the MTV® music program of the month. At the point of purchase the identification number is activated by transaction manager 304. The provider 306 is simultaneously notified of the active status of an identification number. The CD can be downloaded by accessing the MTV® web site 330 via the Internet 336. Once MTV®'s web site 330 is accessed, the consumer is prompted 351 for the identification number. The consumer inputs the active identification number and receives an authorization 352 to download 353 the desired MTV® music program. The MTV® program is downloaded to the blank CD 353. Once the download is complete, the access to the file terminates 354. In one embodiment, multiple identification numbers are provided on the data encoded card for additional authorized access. Additional identification numbers can be used for additional download of music or literature. For example, simultaneously activated identification numbers can be used to facilitate delivery of products or services at a later date.

Another feature of the invention is that the magnetic or optical disks are either blank or have a program that initiates contact with a designated server. For example, with respect to CDs, after the buyer installs the CD in the CD drive, the CD initiates contact with a web site that facilitates the remote download of the desired file.

These features discussed for musical and literary products can be applied to other products and services.

2. Extended Warranties:

Extended warranties are used by consumers of products to prepay for certain repairs or replacement over a set period of time. An extended warranty is usually sold at the time of purchase. Presently, a consumer fills out a form at the time of purchase and pays a fee for an extension of the warranty. The merchant sends the completed form to an administrative service, such as NEW to administer the warranty extension. The merchant pays a fee for this administrative service. If the product is in need of repair the consumer contacts the administrative repair company to arrange for the repairs.

Now referring to FIGS. 47 and 48, a merchant, however, could manage this administrative function in house using the present point of sale activated delivery system. For example, a cold data encoded card, referred to here in this context as an administration of contract card 360, is available at the point of sale to the consumer when the consumer purchases a product. If a consumer purchases an administrative contract card 360 at the point of sale for the associated goods, the activated administrative contract card is swiped thorough a POS terminal device 302. The identification number encoded on the card is transmitted by any form of electronic communication to the transaction manager 304. The transaction manager 304 activates the identification number and opens a file 368 relating to the extended warranty.

More specifically, this system is divided into issuance of an activated card and redemption of the activated card. First, an extended warranty card 360 is made. The manufacturer of the product to be warranted associates a serial number of a product with an identification number. This identification number is encoded on a card 360. The card 360 is cold and does not provide the service until activated. The card 360 is swiped through POS terminal device 302 and activated by the transaction manager 304. The identification number is activated and a pre-determined monetary amount is activated for use within the specified contract term. This is referred to as the activated administration of contract card 370. A contract relating to the warranty contract is stored in transaction manager database 342 and provider database 368. The consumer retains the activated administration of contract card 370. In an alternative embodiment, an extended warranty is encoded in a computer chip or hard drive and is printed out in response to the data encoded reader receiving an active identification number.

If the consumer needs repair or replacement, the activated administration of contract card 370 is returned to the store and swiped through a POS terminal device 302. The transaction manager 304 opens file and then approves repairs or replacement depending on the type of extended warranty purchased by the consumer. The provider database 368 can be notified by the POS terminal device 302 or by an electronic communication from the transaction manager 304.

3. Services:

Various services can be activated by swipe activation of a data encoded card. These services include DirectTV®, TimeWarner® Cable, Internet gaming, ISP and DSL. Now referring to FIGS. 49 and 50, for example, with respect to DirectTV®, a data encoded card 380 of the present invention is purchased from a retailer at the point of sale, the identification number on the cold data encoded card 380 is read by a POS terminal device 302 and the identification number is transmitted to the transaction manager 304. The transaction manager 304 activates the identification number and transmits the activated status to a the selected retail provider 306 and merchant computer 331. The POS terminal device 302 provides an activated card 370.

Now referring to FIG. 50, to use the activated card 370, the consumer can contact, via all electronic communication methods, in one instance the consumer telephones a specified 800 number or makes connection 385 with a provider via an ISP, DSL or wireless connection. The consumer enters 386 the activated identification number 386 and the hardware serial number 387 for the DirectTV® box and receives access to the purchased service 387. This can be a single event or fractional time span (day, week or month). The same routine is used for cable and ISP or DSL service. With respect to ISP and DSL service, the hardware serial prompt will ask for the serial number of the modem. The provider 306, upon receiving the active identification number and hardware serial number 387, authorizes 389 the connection to the service as specified on the card 370. The service is then downloaded 390.

4. Insurance

With respect to FIGS. 51 and 52, with respect to insurance, a monthly car insurance, an insurance card 400 is made. The seller of insurance associates a serial number of a product with an identification number. This identification number is encoded on a card. More specifically, the insurance card 400 is swiped through POS terminal device 302 and activated by the transaction manager 304. The identification number encoded on the card is activated and a predetermined monetary amount is activated for use within the specified contract term. The contract is stored in transaction database 342 and provider database 368. The consumer retains the insurance card 402. If the consumer needs insurance service, the activated insurance card 402 is taken to a repair or rental facility and read with a POS terminal device 302. The transaction manager 304 activates contract for files 368 and 342 and then authorizes the contracted insurance services.

5. Software

In the manufacture of software an association file is made between a copy of the software and the serial number of the product. The activated delivery system can be managed by either a transaction manager 304 or a provider 306. A card 16 is encoded with an identification number. The card 16 is packed with or without an optical disk or cartridge. The activated delivery system for software provides licensing control through registration associated with the point of sale delivery of the software.

An optical disk is manufactured that is blank or is missing an execute file. The serial number of the product is associated with an identification number. The card associated with the serial number can be packaged in a package with the optical disk or cartridge. The package is displayed on a retailer's shelf. When a consumer purchases the card/package combination, the data encoded card 16 is read using a POS terminal device 302 as previously shown. The POS terminal device 302 is in electronic communication with the provider 306. A provider 306 activates the identification number on the data encoded card 16.

Now referring to FIG. 53, the consumer computer 308 makes an ISP Internet connection 350 with provider. The provider asks 351 the consumer for the identification number. If the correct number is given registration material 390 is provided by an ISP Internet connection 350 to consumer computer 308. The consumer completes the registration material and electronically returns 350 the document to provider's computer 332. As part of this registration process, the serial number of the consumer's modem or computer is communicated to provider's computer 391. This registration information is recorded in the file associated with the active identification number 340.

Once registration is completed, the provider can authorize download 352 of the file, the execution file necessary to operate or run the software or an encryption key that provides access to the software program present on the disk or cartridge 353 and the content can be downloaded to the consumer computer via an electronic means such as the Internet. After the content is downloaded access is terminated.

If another user tries to request the download of the file associated with the PIN, access would be denied if the registration information did not match.

Customer service can be provided at a later date for maintenance problems such as hard drive failure. This service is related to the activation number.

Although the present invention has been described and illustrated with respect to a preferred embodiment and a preferred use thereof, it is not so limited since modifications and changes can be made therein which are within the full scope of the invention.

I claim:

1. A method to facilitate delivery of a product from a provider to a consumer; the method comprising the steps of:
(a) associating a serial number of said product with an identification number;
(b) recording said identification number on a card;
(c) activating said identification number on said card at a point of sale; and
(d) facilitating delivery of said product from said provider to said consumer.

2. The method of claim 1 wherein said card is attached to a package.

3. The method of claim 2 wherein said package includes a content storage device.

4. The method of claim 1 wherein the identification number is activated by a transaction manager.

5. The method of claim 1 wherein the identification number is activated by said provider.

6. The method of claim 1 wherein said product is selected from the group consisting of video games, music and literature.

7. The method of claim 1 further comprising the step of recording a control number on said card.

8. The method of claim 1 further comprising the step of recording a means to contact said provider on said card.

9. The method of claim 1 comprising the step of facilitating the delivery of said products by downloading said products to a content storage device.

10. The method of claim 1 comprising the step of facilitating the delivery of said products by downloading said products to a consumer's computer.

11. The method of claim 1 wherein the identification number is recorded on said card using a bar code.

12. The method of claim 1 wherein the identification number is recorded on said card using a magnetic stripe.

13. The method of claim 1 wherein the identification number is recorded on said card using a computer chip.

14. The method of claim 1 wherein the identification number is recorded on said card using a hard drive.

15. The method of claim 1 wherein the identification number is printed on said card.

16. The method of claim 1 wherein more than one identification number is provided.

17. The method of claim 1 wherein said identification number is obscured.

18. The method of claim 1 wherein said card is attached to a package.

19. A method to facilitate delivery of a service from a provider to a consumer, the method comprising the steps of:
(a) providing an identification number associated with said service;
(b) recording said identification number on a card;
(c) activating said identification number on said card at a point of sale; and
(d) facilitating delivery of said service from said provider to said consumer.

20. The method of claim 19 wherein said card is attached to a package.

21. The method of claim 20 wherein said package includes a content storage device.

22. The method of claim 19 wherein said identification number is activated by a transaction manager.

23. The method of claim 19 wherein said identification number is activated by a provider.

24. The method of claim 19 further comprising the step of recording a control number on said card.

25. The method of claim 19 further comprising the step of recording a means to contact said provider on said card.

26. The method of claim 19 wherein said identification number is recorded on the card using a magnetic stripe.

27. The method of claim 19 wherein said identification number is recorded on the card using a computer chip.

28. The method of claim 19 wherein said identification number is recorded on the card using a hard drive.

29. The method of claim 19 wherein said identification number is recorded on the card using a bar code.

30. The method of claim 19 wherein said service is selected from the group consisting of: extended warranty, insurance, cable, ISP, and DSL.

31. The method of claim 19 wherein more than one identification number is provided on said card.

32. The method of claim 19 wherein said service is a single event.

33. The method of claim 19 wherein said service is a fractional time span.

34. A method of using a card and package combination to activate delivery of a product or a service from a provider, the card including a data encoded portion, said card being secured to a package; the method comprising the steps of:
(a) encoding an identification number on to the data encoded portion of said card;
(b) using a POS terminal device to read the encoded identification number while said card is secured to secured to a package;
(c) then transmitting the identification number from a POS terminal device to a transaction manager;
(d) activating the identification number by the transaction manager;
(e) then providing said active identification number to said provider by said transaction manager;
(f) requesting delivery of said product or said service by a consumer from said provider by providing said active identification number to said provider; and
(g) delivering said product or said service to said consumer from said provider in response to said provider receiving the active identification number.

35. The method of claim 34 wherein more than one identification number is provided.

36. The method of claim 34 wherein said data encoded portion provides a control number.

37. The method of claim 34 wherein said data encoded portion identifies the provider.

38. The method of claim 34 wherein said data encoded portion identifies the product or service to be delivered.

39. The method of claim 34 wherein said data encoded portion directs the transmission of the identification number to the provider.

40. The method of claim 34 wherein said data encoded portion directs the transmission of the identification number to a transaction manager.

41. The method of claim 34 wherein said data encoded portion is selected from the group consisting of a magnetic stripe; a computer chip; a hard drive; and a barcode.

42. The method of claim 34 wherein said consumer provides the identification number to the provider via the Internet.

43. The method of claim 34 wherein said consumer provides the identification number to said provider via a phone line.

44. The method of claim 34 wherein said package includes a content storage device.

45. The method of claim 34 wherein said package includes a control number.

46. A method of using a card and package combination to activate delivery of a product or a service by a provider, said card and package combination comprising a package and said card including a data encoded portion, said card being secured to the package; said method comprising the steps of:
(a) encoding an identification number on to said data encoded portion of said card;
(b) using a POS terminal device to read said encoded identification number, while said card is secured to the package;
(c) then transmitting said identification number from said POS terminal device to a provider;
(d) activating said identification number by said provider;
(e) then requesting delivery of said product or said service by a consumer from said provider, by providing said active identification number to said provider; and
(f) delivering said product or said service to said consumer from the provider in response to said provider receiving said active identification number.

47. The method of claim 46 wherein more than one identification number is provided.

48. The method of claim 46 wherein said data encoded surface provides a control number.

49. The method of claim 46 wherein said data encoded portion identifies the product or service to be delivered.

50. The method of claim 46 wherein said data encoded portion directs the transmission of the identification number to the provider.

51. The method of claim 46 wherein said data encoded portion directs the transmission of the identification number to said transaction manager.

52. The method of claim 46 wherein said data encoded portion is selected from the group consisting of a magnetic stripe; a computer chip; a hard drive and a barcode.

53. The method of claim 46 wherein said package includes a content storage device.

54. The method of claim 46 wherein said package includes a control number.

55. The method of claim 46 wherein said consumer provides said identification number to said provider via the Internet.

56. The method of claim 46 wherein said consumer provides said identification number to said provider via a phone line.

57. The method of claim 46 wherein said identification number is printed on said card.

58. The method of claim 46 wherein said identification number is obscured.

59. A method of using a card to facilitate delivery of a product to a consumer, the card including at least one data encoded portion, the method comprising the steps of:
(a) encoding an identification number on to said at least one data encoded portion of said card;
(b) using a POS terminal device to read an encoded identification number on said card;
(c) then transmitting said identification number from said POS terminal device to a transaction manager or a provider;
(d) activating the identification number by said transaction manager or said provider;
(e) transmitting said active identification number to said POS terminal device;
(f) providing said active identification number from said POS terminal device to a consumer; and
(g) facilitating the delivery of said product, by said consumer providing said provider with said active identification number.

60. The method of claim 59 further comprises the steps of:
(a) transmitting the active identification number to the POS terminal device, the POS terminal device being in electronic communication with a means to print; and
(b) printing said active identification number in response to receiving the active identification number by the POS terminal device.

61. The method of claim 59 wherein the data encoded portion of the card encodes licensing documents, the method further comprises the steps of:
(a) providing the active identification number to said POS terminal device; said POS terminal device being in electronic communication with a means to print;
(b) then accessing licensing documents encoded in said data encoded portion in response to said active identification number, and
(c) printing the licensing documents in response to receiving the active identification number.

62. The method of claim 59 wherein facilitating the delivery of said product includes writing said product to a content storage device.

63. The method of claim 59 wherein said identification number is printed on said card.

64. The method of claim 59 wherein said identification number is printed on said card and said identification number is obscured.

65. A method to administer contracted services comprising the steps of:
(a) providing a data encoded card having a predetermined contract value and an identification number associated with said predetermined contract value;
(b) facilitating activation of said identification number at a point of sale; and
(c) facilitating delivery of said contracted services.

66. The method of claim 65 wherein said contracted service is warranty extension

67. The method of claim 65 wherein said contracted service is insurance.

68. A method of using a card having a data encoded portion to administer contracted services, the method comprising the steps of:
(a) associating a pre-determined contract value and an identification number;
(b) encoding said identification number on to the data encoded portion of said card to provide an administration of contract card;
(c) issuing said administration of contract card at a point of sale to a consumer;
(d) transmitting said identification number from a POS terminal device to a transaction manager;
(e) activating the identification number by said transaction manager to provide an activated administration of contract card;
(f) opening a file associated with said identification number by said transaction manager;
(g) redeeming said activated administration card by transmitting the identification number from said POS terminal device to said transaction manager; and
(h) authorizing said contracted services.

69. The method of claim 68 further comprising the step of transmitting said active identification number to said provider.

70. The method of claim 68 further comprising the step of printing a contract encoded in the data encoded card by said POS terminal device.

71. The method of claim 68 wherein said contracted service is extended warranty.

72. The method of claim 68 wherein said contracted service is insurance.

73. A method to provide point of sale generated access to a remote file in a transaction between a merchant, provider, transaction manager and a consumer comprising:
(a) providing a card having a data encoded portion, the encoded data including an identification number;
(b) reading the data encoded portion with a point of sale terminal device;
(c) transmitting the data from POS terminal device to the transaction manager;
(d) activating the identification number by the transaction manager;
(e) transmitting the activated identification number to a provider from the transaction manager;
(f) accessing a provider's web site by a consumer;
(g) providing the identification number to the provider to obtain authorization for the consumer to access said remote file; and
(h) downloading said remote file to a content storage device.

74. The method of claim 73 wherein the provider creates a URL corresponding to said file.

75. The method of claim 73 wherein the consumer receives the URL for the said file.

76. The method of claim 73 wherein said card is attached to a package.

77. The method of claim 73 wherein said content storage device is pre-written with a URL corresponding to said remote file.

78. A method to provide point of sale generated access to a remote file in a transaction between a merchant, provider, and a consumer comprising:
(a) providing a card having a data encoded portion, the encoded data including an identification number;
(b) reading the data encoded portion with a point of sale terminal device;
(c) transmitting the data from the point of sale terminal device to the provider;
(d) activating the identification number by the provider;
(e) accessing a provider's web site by the consumer;
(f) providing the identification number to the provider to obtain authorization for the consumer to access said remote file; and
(g) downloading said remote file to a content storage device.

79. The method of claim 78 wherein the provider creates a URL authorized file.

80. The method of claim 78 wherein the consumer receives the URL for the authorized file.

81. The method of claim 78 wherein said card is attached to a package.

82. The method of claim 78 wherein the disk is pre-written with a provider's URL.

83. A method of providing a consumer with a data encoded card, including an active identification number, for providing activated delivery of products or services, the method comprising the steps of:
(a) providing a card with a data writable portion capable of receiving an identification number;
(b) using a point of sale terminal device to contact a transaction manager;
(c) requesting an active identification number from the transaction manager;
(d) transmitting said active identification number from the transaction manager to the point of sale terminal wherein the point of sale terminal device encodes said active identification number on to the data writable portion of said card; and
(e) providing a consumer with the data encoded card including said active identification number.

84. The method of claim 83 wherein the data encoded card is pre-encoded with a specific product of service.

85. The method of claim 83 wherein said data writable portion is a hard drive.

86. The method of claim 83 wherein data writable portion is a computer chip.

87. A method to prevent consumer sharing of a software program owned by a software provider; the method comprising the steps of:
(a) associating a serial number of a software program with an identification number;
(b) recording an identification number on a data encoded portion of a card;
(c) activating said identification number at a point of sale;
(d) providing said active identification number to a software provider by a consumer;
(e) transmitting a registration requirement to said consumer from said software provider, wherein said registration requirement associate a consumer's computer equipment with said identification number; and
(f) preventing consumer sharing of said software program by downloading said software program to said consumer's computer equipment associated with said active identification number.

88. The method of claim 87 wherein the provider delivers an encrypted key to allow consumer to operate the software.

89. The method of claim 87 wherein the provider delivers an execution file to allow the consumer to open the software program

90. The means of claim 87 wherein said data encoded card is attached to a package.

91. The method of claim 87 wherein said data encoded card is attached to a package, said package further includes a content storage device.

92. The method of claim 87 wherein said identification number is printed on a card.

93. The method of claim 87 wherein said identification number is printed on a card and the number is obscured.

94. The method of claim 87 wherein said data encoded portion is selected from the group consisting of: a magnetic stripe; a computer chip; a hard drive; and a barcode.

95. A method of using a card and package combination to activate delivery of a software program or portion thereof from a provider to a consumer, the card including a data encoded portion and the card being secured to the package, the method comprising:
(a) encoding an identification number on to the data encoded portion of said card;
(b) using a POS terminal device to read the encoded identification number from the data encoded portion of said, while said card is secured to said package;
(c) then transmitting said identification number from said POS terminal device to a provider;
(d) then activating said identification number by said provider;
(e) providing said identification number to said provider by a consumer;
(f) transmitting a registration contract by said provider to said consumer in response to said identification number;
(g) transmitting a completed registration contract including consumer's computer serial number or modem serial number to said provider; and
(h) then delivering said software program or portion thereof to said consumer from said provider.

96. The method of claim 95 wherein said package includes a blank optical disk.

97. The method of claim 95 wherein said package includes a blank magnetic disk.

98. The method of claim 95 wherein said package includes a cartridge.

99. The method of claim 95 wherein said package includes an inoperative disk.

100. The method of claim 95 wherein said provider delivers an execution file.

101. The system of claim 95 wherein said data encoded card is a barcode.

102. A system for point of sale activated delivery of a product comprising:
(a) a data encoded card, said data including a unique identification number facilitating the delivery of said product; and
(b) a transaction manager in electronic communication with a point of sale terminal.

103. The system of claim 102 further comprising a provider in electronic communication with said transaction manager.

104. The system of claim 103 further comprising a consumer computer in electronic communication with said provider.

105. The system of claim 104 further comprising a consumer phone in electronic communication with said provider.

106. A system for point of sale activated delivery of a product comprising:
(a) a data encoded card having a unique identification number facilitating the delivery of said product; and
(b) a provider in electronic communication with a point of sale terminal.

107. The system of claim 106 further comprising a consumer computer in electronic communication with said provider.

108. The system of claim 106 further comprising a consumer phone in electronic communication with said provider.

109. A delivery device for use in a system for point of sale activated delivery of products or services, said delivery device comprising:
(a) a package;
(b) a content storage device retained by said package; and
(c) a data-encoded card secured to said package, said data-encoded card including a data-containing portion which is readable by a point of sale terminal device, said data-containing portion including at least one unique identification number.

110. The delivery device as recited in claim 109, wherein:
said package includes first and second panels attached to one another.

111. The delivery device as recited in 109, wherein:
said first and second panels of said package each include an aperture formed in an upper portion thereof and extending therethrough, said apertures of said first and second panels being aligned with one another when said package is in a closed position, said apertures being suitable for receiving a device used to support and display the delivery device.

112. The delivery device as recited in claim 109, wherein:
said package includes a scored interface between said first and second panels, said interface being scored to facilitate folding one of said first and second panels on top of the other of said first and second panels.

113. The delivery device as recited in claim 109, wherein:
said package further includes an insert made of a clear plastic material,
said insert being secured to one of said first and second panels;
said content storage device being disposed within said insert such that at least a portion of said content storage device is viewable from a position exterior of said delivery device.

114. The delivery device as recited in claim 113, wherein:
said one of said first and second panels of said package includes an aperture formed therein and extending therethrough, said aperture being effective for receiving a portion of said insert therethrough.

115. The delivery device as recited in claim 113, wherein:
said insert includes a container portion having an open top and a peripheral flange integral with said container portion adjacent said top;
said one of said first and second panels includes inside and outside surfaces, said peripheral flange of said insert being secured to said inside surface, said container portion of said insert protruding through said aperture and beyond said outer surface.

116. The delivery device as recited in claim 111, wherein:
said other of said first and second panels includes a notch formed in a lower portion thereof;
said package further includes a window secured to said other of said first and second panels, said window being made of a clear plastic material such that at least a portion of said data-encoded card is viewable from a position exterior of said delivery device.

117. The delivery device as recited in claim 116, wherein:
said window includes a pane extending across said notch and a frame integral with said pane, said frame being secured to said other of said first and second panels.

118. The delivery device as recited in claim 117 wherein:
said light-emitting material of said window is Mylar®.

119. The delivery device as recited in claim 116, wherein:
said one of said first and second panels further includes a notch formed in a lower portion thereof;
said package further includes a window secured to said one of said first and second panels, said window being made of a clear plastic material such that at least a portion of said data-encoded card is viewable from a position exterior of said delivery device.

120. The delivery device as recited in claim 119, wherein:
said window includes a pane extending across said notch and a frame integral with said pane, said frame being secured to said one of said first and second panels.

121. The delivery device as recited in claim 109, wherein:
said package comprises a box having a flap;
said content storage device is disposed within said box;
said data-encoded card is secured to said flap.

122. The delivery device as recited in claim 109, wherein:
said package includes a single panel.

123. The delivery device as recited in claim 122, wherein:
said single panel includes a lower portion, a remaining portion and a laterally extending score forming an interface between said lower portion and said remaining portion whereby said lower portion is bendable away from said data-encoded card to reveal a lower portion of said data-encoded card;
said data-encoded card being secured to said remaining portion of said single panel, said lower portion of said single panel extending below said card when said lower portion is not bent.

124. The delivery device as recited in claim 122, wherein:
said single panel includes an aperture formed in an upper portion thereof and extending therethrough, said aperture being suitable for a device used to support and display said delivery device.

125. The delivery device as recited in claim 122, wherein:
said package further includes an insert made of a clear plastic material, said insert being secured to said single panel;
said content storage device is disposed within said insert such that at least a portion of said content storage device is viewable from a position exterior of said delivery device.

126. The delivery device as recited in claim 125, wherein:
said single panel includes an aperture formed therein and extending therethrough, said aperture being effective for receiving a portion of said insert therethrough.

127. The delivery device as recited in claim 126, wherein:
said insert includes a container portion having an open top and a peripheral flange integral with said container portion adjacent said top;
said single panel includes front and rear surfaces, said peripheral flange of said insert being secured to one of said front and rear surfaces, said container portion of said insert protruding through said aperture and beyond the other of said front and rear surfaces.

128. The delivery device as recited in claim 109, wherein said content storage device is an optical disk.

129. The delivery device as recited in claim 109, wherein said content storage device is a magnetic disk.

130. The delivery device as recited in claim 109, wherein said content storage device is a compact disk containing music thereon.

131. The delivery device as recited in claim 109, wherein said content storage device is a game cartridge.

132. The delivery device as recited in claim 109, wherein said content storage device is a book.

133. The delivery device as recited in claim 109, wherein said content storage device includes a box and a device disclosed within said box, said device comprising at least one of an optical disk, a magnetic disk, a compact disk containing music thereon, a game cartridge and a book.

134. The delivery device as recited in claim 109, wherein said data-encoded card includes front and rear surfaces and said data-containing portion comprises a magnetic stripe disposed on one of said front and rear surfaces.

135. The delivery device as recited in claim 134, wherein said magnetic stripe is laminated onto said one of said front and rear surfaces.

136. The delivery device as recited in claim 134, wherein said magnetic stripe is rolled onto said one of said front and rear surfaces.

137. The delivery device as recited in claim 134, wherein said magnetic stripe is encoded with a unique identification number that is correlated with a product or service to be delivered.

138. The delivery device as recited in claim 134, wherein said data-encoded card further includes a smart chip secured to said one of said front and rear surfaces.

139. The delivery device as recited in claim 134, wherein said data-encoded card further includes a bar code imprinted on said one of said front and rear surfaces.

140. The delivery device as recited in claim 134, wherein said data-encoded card further includes a hard drive ridge formed on said one of said front and rear surfaces.

141. The delivery device as recited in claim 109, wherein said data-encoded card includes front and rear surfaces and said data-containing portion comprises a hard drive ridge formed on one of said front and rear surfaces.

142. The delivery device as recited in claim 140, wherein said hard drive ridge is encoded with a unique identification number that is correlated with a product or service to be delivered.

143. A delivery device for use in a system for point of sale activated delivery of products, said delivery device comprising:
(a) a package;
(b) a hard drive card secured in said package, said hard drive card including a data containing portion which is readable and writable by a point of sale terminal device, said data-containing portion including at least one unique identification number and the product to be delivered, wherein said package includes a pictorial representation of the product to be delivered.
